(19) United States
(12) Patent Application Publication
(10) Pub. No.: US 2007/0248879 A1
(43) Pub. Date: Oct. 25, 2007

(54) Alkaline battery including nickel oxyhydroxide cathode and zinc anode

(76) Inventors: Richard E. Durkot, East Walpole, MA (US); Kristin G. Shattuck, New York, NY (US); Fanny Barde, Auderghem (Oudergem) (BE); Jean-Marie Tarascon, Paris (FR); Dean MacNeil, Toronto (CA); Paul A. Christian, Norton, MA (US)

Correspondence Address: MR. BARRY D. JOSEPHS;ATTORNEY AT LAW, 19 NORTH STREET, SALEM, MA, 01970, US

(21) Appl. No.: 11/820,781

(22) Filed: Jun. 20, 2007

Related U.S. Application Data
(63) Continuation-in-part of application No. 10/831,899, filed on Apr. 26, 2004.
Application No. 10/831,899 is a continuation-in-part of application No. 10/228,957, filed on Aug. 28, 2002, now Pat. No. 6,991,875.

(51) Int. Cl. H01M 2/14

(52) U.S. Cl. 429/130

(57) ABSTRACT

A primary alkaline battery includes a cathode including a nickel oxyhydroxide and an anode including zinc or zinc alloy particles. Performance of the nickel oxyhydroxide alkaline cell is improved by adding zinc fines to the anode and by including an oxidation resistant graphite in the cathode as well as in a conductive coating applied to the inside surface of the cell housing.

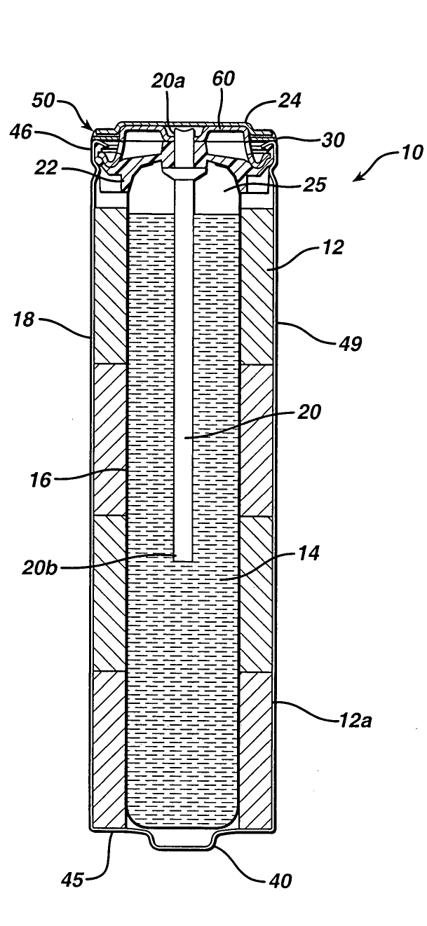

### CROSS REFERENCE TO RELATED APPLICATIONS

This application is a continuation in part of application Ser. No. 10/831,899, filed Apr. 26, 2004, which is a continuation in part of Ser. No. 10/228,957 filed Aug. 28, 2002, now U.S. Pat. No. 6,991,875 B2.

### FIELD OF THE INVENTION

This invention relates to an alkaline battery including a nickel oxyhydroxide cathode and a zinc-based anode and a method of manufacturing an alkaline battery.

### BACKGROUND

Conventional alkaline electrochemical cells are primary (non-rechargeable) cells having an anode comprising zinc, a cathode comprising manganese dioxide, and an alkaline electrolyte. The cell is formed of a cylindrical housing. The housing is initially formed with an open end. After the cell contents are introduced, an end cap that forms the negative terminal with insulating plug such as plastic grommet is inserted into the open end. The cell is closed by crimping the housing edge over an edge of the insulating plug and radially compressing the casing around the insulating plug to provide a tight seal. The housing serves as the cathode current collector and a portion of the housing forms the positive terminal.

In general, a primary alkaline cell includes an anode, a cathode, an electrolyte permeable separator between the anode and the cathode, typically containing a cellophane film, and an alkaline electrolyte contacting both the anode and the cathode. The anode includes an anode active material comprising zinc or zinc alloy particles and conventional gelling agents, such as carboxymethylcellulose or acrylic acid copolymers, and electrolyte. The gelling agent serves to immobilize the zinc particles in a suspension such that the zinc particles are in contact with one another. An anode current collector, typically a conductive metal nail is inserted into the gelled zinc anode. The alkaline electrolyte is typically an aqueous solution of potassium hydroxide, but can include aqueous solutions of sodium or lithium hydroxide. The cathode includes a cathode active material comprising manganese dioxide or nickel oxyhydroxide or mixtures thereof and an electrically-conductive additive, such as graphite, to increase electrical conductivity of the cathode.

A common problem associated with the design of primary alkaline cells, zinc/manganese dioxide cells in particular, is the tendency for a cell to generate hydrogen gas when it is discharged below a certain voltage, typically at or near the endpoint of the useful capacity of the cell. Zinc/manganese dioxide cells typically are provided with a rupturable diaphragm or membrane located within the end cap assembly of the cell. Such a rupturable diaphragm or membrane can be formed within a plastic insulating member as described, for example, in U.S. Pat. No. 3,617,386. When internal gas pressure increases to a predetermined value, the membrane can rupture thereby venting the gas to the external environment through apertures in the end cap thereby lowering the internal pressure.

Commercial cylindrical alkaline cells are available typically in AA, AAA, AAAA, C, and D sizes. Since commercial cell sizes and the corresponding internal volumes of these cells are fixed, in order to increase cell capacity, i.e., the useful service life of the cell, it has been necessary to increase the interfacial surface area of the electrode active material as well as to include greater amounts of active material in the cell. This approach has several practical limitations. If the active material is packed too densely into the cell this can produce a decrease in the rate of electrochemical reaction during discharge, thereby reducing service life of the cell. Other deleterious effects such as polarization can occur, particularly at high current drains (i.e., in high power applications). Polarization limits mobility of ions within the electrode active material as well as within the electrolyte, thereby reducing service life of the cell. Contact resistance between the cathode active material and the cell housing also can reduce service life.

Another problem associated with a zinc/manganese dioxide primary alkaline cell is that the cell characteristically has a sloping voltage profile, that is, the average running voltage gradually decreases as the cell is discharged. The rate of decrease in voltage is more pronounced as the cell is discharged at higher power drain rates, for example, either constantly or intermittently between about 0.25 and 1 Watt (i.e., between about 0.3 and 1 Amp), particularly between about 0.5 and 1 Watt. Thus, for a zinc/manganese dioxide cell, the actual cell capacity (milli-Amp-hrs) obtained at high power drain rates can be substantially less than at low power drains.

Thus, there is a need for a primary alkaline cell better suited to high power applications. Such a cell could be used as the main power source for a high power device or as a back-up power source to supplement a rechargeable battery to power such devices. Modern electronic devices such as cellular phones, digital cameras, digital audio players, CD/DVD players, handheld televisions, electronic flash units, remote controlled toys, personal digital assistants (i.e., PDAs), camcorders and high-intensity lamps are examples of high power applications. Thus, it is desirable to provide an improved primary alkaline cell having longer service life than a conventional zinc/manganese dioxide alkaline cell of the same size, particularly for use in those applications demanding high power.

Accordingly, it is desirable to provide such an improved alkaline cell in order to extend the useful service life of primary alkaline cells intended for use in high power devices.

It is also desirable to provide an improved alkaline cell having a reduced amount of hydrogen gassing, thereby improving storage characteristics and simplifying requirements for a suitable venting system.

### SUMMARY OF THE INVENTION

A principal aspect of the invention is directed toward a primary (i.e., non-rechargeable) alkaline cell which includes a cathode including nickel oxyhydroxide (i.e., NiOOH), an anode, preferably including zinc, a separator positioned between anode and cathode, and an alkaline electrolyte contacting both anode and cathode.

In an another aspect of the invention, the cathode includes an active cathode material comprising nickel oxyhydroxide, conductive carbon particles including graphite, preferably an oxidation-resistant graphite, and an aqueous alkaline electrolyte solution. Generally, the cathode can include, for example, between 60% by weight and 97% by weight, between 80% by weight and 95% by weight, or between 85% by weight and 90% by weight of nickel oxyhydroxide. Optionally, the cathode also can include an oxidizing additive, a polymeric binder, or combinations thereof. An oxidizing additive is more readily reduced than the active cathode material and can thereby serve as a sacrificial additive. The presence of such an oxidizing additive can serve to stabilize the nickel oxyhydroxide thereby improving storage characteristics of the cell.

The nickel oxyhydroxide of the invention can include a beta-nickel oxyhydroxide, a cobalt oxyhydroxide-coated beta-nickel oxyhydroxide, a gamma-nickel oxyhydroxide, a cobalt oxyhydroxide-coated gamma-nickel oxyhydroxide, a solid solution of a beta-nickel oxyhydroxide and a gamma-nickel oxyhydroxide, a cobalt oxyhydroxide-coated solid solution of a beta-nickel oxyhydroxide and a gamma-nickel oxyhydroxide or a physical mixture of a beta-nickel oxyhydroxide and a gamma-nickel oxyhydroxide. Gamma-nickel oxyhydroxide is a non-stoichiometric phase of nickel oxyhydroxide containing both trivalent nickel and tetravalent nickel and can include a variable amount of water molecules, alkali metal cations, and anionic species inserted into the interlamellar region (viz., van der Waals gap) of the layered crystal structure. The nickel oxyhydroxide can be a powder including particles that have a nominally spherical, spheroidal, or ellipsoidal shape. The average particle size of nickel oxyhydroxide powder can range between 2 and 50 microns or 5 and 30 microns or 10 and 25 microns or 15 and 20 microns. The nickel oxyhydroxide can include at least one bulk dopant. The bulk dopant can include aluminum, manganese, cobalt, zinc, gallium, indium, or combinations thereof. The bulk dopant can be present at a relative weight percentage of less than about 10%, less than about 5% or less than about 2%. A bulk dopant can serve to reduce the open circuit voltage (OCV) of the cell slightly thereby decreasing oxidation of electrolyte during storage. Thus, the presence of a bulk dopant in nickel oxyhydroxide can improve storage characteristics of the cell.

Nickel oxyhydroxide particles can be coated with cobalt oxyhydroxide to cover at least 60% of their surface, at least 70%, at least 80%, at least 90% of their surface. Cobalt oxyhydroxide-coated nickel oxyhydroxide can be prepared from nickel hydroxide coated with between 2% and 15%, between 3% and 10% or between 4% and 6% cobalt hydroxide by weight. The cobalt oxyhydroxide coating can enhance inter-particle electrical contact between nickel oxyhydroxide particles in the cathode thereby improving bulk electrical conductivity of the cathode. The cobalt oxyhydroxide coating also can contribute to maintaining cell performance when a cell is stored for extended periods at high temperatures, for example, at 60° C. (140° F.). The cobalt oxyhydroxide coating can optionally include a dopant including, for example, sodium, magnesium, calcium, strontium, barium, scandium, yttrium, lanthanum, rare earth elements, titanium, zirconium, hafnium, chromium, manganese, nickel, copper, silver, zinc, cadmium, aluminum, gallium, indium, bismuth or combinations thereof.

The anode comprises zinc particles including any of the zinc-based particles conventionally used in slurry anodes for alkaline cells. The term zinc or zinc powder as used herein shall be understood to include zinc alloy powder which comprises a very high concentration of zinc and as such functions electrochemically essentially as pure zinc.

The anode can include, for example, between 60 wt. % and 80 wt. %, between 62 wt. % and 75 wt. %, preferably between about 62 wt. % and 72 wt. % of zinc particles admixed with gelling agent and aqueous alkaline electrolyte. The electrolyte can be an aqueous solution of alkali hydroxide, such as potassium hydroxide, sodium hydroxide, lithium hydroxide, or mixtures thereof. The electrolyte can contain between 15 wt. % and 60 wt. %, between 20 wt. % and 55 wt. %, or between 30 wt. % and 50 wt. % alkali hydroxide dissolved in water. The electrolyte can contain 0 wt. % to 6 wt. % of a metal oxide, such as zinc oxide. The zinc-based powder can have a mean average particle size, for example, between about 1 and 350 microns, desirably between about 1 and 250 microns, preferably between about 20 and 250 microns. Particle size and mean average particle size as reported herein, unless otherwise specified shall be construed as determined by the more common method employed in the art for determining particle size, namely, by laser diffraction based on a particle size distribution versus volume percent. The zinc or zinc alloy particles can be generally acicular in shape, having a length along a major axis at least two times a length along a minor axis, or the particles can be generally flake-like, each flake generally having a thickness of no more than about 20 percent of the maximum linear dimension of the particle.

In an aspect of the invention, the anode comprises zinc fines which are preferably mixed with zinc particles of larger average particle size. Thus in one aspect, the anode desirably includes at least 10 wt. %, at least 15 wt. %, at least 30 wt. %, or at least 80 wt. %, typically between 35 and 75 wt. % of the total zinc or zinc alloy particles small enough to pass through a 200 mesh size screen. Such −200 mesh zinc fines typically can have a mean average particle size between about 1 and 75 microns. Even very small amounts of zinc or zinc alloy particles, for example, at least about 5 wt. % or even at least about 1 wt. % of the total zinc or zinc alloy particles which are small enough to pass through a 200 mesh size screen, can have a beneficial effect on the anode performance of cells with cathodes comprising nickel oxyhydroxide. As used herein “zinc fines” are zinc-based particles small enough to pass through a 200 mesh size sieve. (viz., a sieve having square openings of 0.075 mm.) A table for converting between mesh size and square sieve opening size is included in the Detailed Description section. At least 25 wt. %, for example, at least 50 wt. % of the zinc or zinc alloy particles can have a larger particle size (e.g., −20/+200 mesh), that is, so that they will pass through a 20 mesh size sieve and are retained by a 200 mesh size sieve (i.e., a sieve having square openings of between about 0.850 mm and 0.075 mm). For example, when the total zinc in the anode comprises 10 wt. % zinc fines (batch 1) of 200 mesh size mixed with 90 wt. % larger size zinc particles (batch 2) between 20 and 200 mesh size, the mean average particle size of the total zinc particles may, for example, be about 340 microns. When the total zinc in the anode comprises 50 wt. % zinc fines (batch 1) of −200 mesh size mixed with 50 wt. % larger size zinc particles (batch 2) of between 20 and 200 mesh size, the mean average particle size of the total zinc particles, for example, can be about 200 microns. When the total zinc in the anode comprises 100 wt. % zinc fines of −200 mesh size, the mean average particle size of the total zinc particles typically can be between about 1 and 75 micron, for example, about 75 microns.

In another aspect, at least about 10 wt. %, at least 45 wt. %, or at least 80 wt. % of the zinc or zinc alloy particles can pass through a sieve of 325 mesh size (i.e., a sieve having square openings of 0.045 mm). The mean average particle size of a fraction of zinc-based particles capable of passing through a 325 mesh size sieve can typically be between about 1 and 35 microns, for example, about 35 microns. However, it should be understood that a portion of such a fraction can be comprised of very small zinc-based particles in the range from 1 to 35 microns, for example or between about 5 and 35 microns or between about 5 and 25 microns. Even very small amounts, for example, at least about 5 wt. % or even at least about 1 wt. % of the total zinc or zinc alloy particles which are small enough to pass through a 325 mesh sieve, can have some beneficial effect on anode performance of cells with cathodes comprising nickel oxyhydroxide. At least 25 wt. %, for example, at least 50 wt. % of the zinc or zinc alloy particles can be larger, such that they can pass through a sieve having a mesh size between about 20 and 200. (i.e., a square opening of between about 0.850 mm and 0.075 mm). For example, when the total zinc in the anode includes 10 wt. % zinc fines (batch 1) of 325 mesh size mixed with 90 wt. % of larger zinc-based particles (batch 2) having a mesh size of between 20 and 200, the mean average particle size of the total zinc-based particles can for example, be about 314 microns. When the total zinc in the anode includes 50 wt. % zinc fines (batch 1) of −325 mesh size mixed with 50 wt. % larger size zinc-based particles (batch 2) of between 20 and 200 mesh size, the mean average particle size of the total zinc-based particles can, for example, be about 125 microns. When the total zinc in the anode comprises 70 wt. % zinc fines (batch 1) of −325 mesh size mixed with 30 wt. % of larger size zinc-based particles (batch 2) of between 20 and 200 mesh size, the mean average particle size of the total zinc-based particles may, for example, be about 50 microns. When the total zinc-based particles in the anode comprises 100 wt. % zinc fines of −325 mesh size, the mean average particle size of the total zinc-based particles, for example, can be about 35 microns. It will be appreciated that the mean average particle sizes as given above are representative of the given mixtures and can vary somewhat depending on the specific particle size distribution within each fraction.

The inclusion of zinc fines in the anode has been determined to improve overall performance of zinc/nickel oxyhydroxide cells at both high and low drain rates for a given size cell. It is theorized that the addition of zinc fines increases the total surface area of the zinc-based particles in the anode. Nickel oxyhydroxide cathodes are well known to have excellent high drain rate capability. The greater total surface area of a mixture of zinc-based particles containing zinc fines can improve overall rate capability of the zinc anode thereby providing a better match with the nickel oxyhydroxide cathode, thereby improving overall cell performance.

The addition of zinc fines to the anode of a zinc/nickel oxyhydroxide primary cell allows the cell to be discharged at higher drain rates (either constant or intermittent current) for a longer period than if such zinc fines were not included. But discharge at higher rate can result in an increase in the cell's internal temperature. An increase in the cell's internal temperature can in turn promote direct attack on and oxidation of graphite by the nickel oxyhydroxide in the cathode, thereby resulting in loss of cell capacity and rate capability. It is concluded herein that the use of an oxidation resistant graphite in the nickel oxyhydroxide cathode reduces the rate at which the graphite can be attacked and oxidized directly by the nickel oxyhydroxide. This is in measure owing to the highly crystalline nature of the oxidation resistant graphite which makes it less susceptible to direct attack by nickel oxyhydroxide.

In an aspect of the invention, graphites having a low Raman defect ratio which is defined herein as the ratio of the integrated areas under peaks centered at about 1330 to 1360 cm⁻¹ and 1570-1580 cm⁻¹ appearing in the first order Raman spectrum of the graphite, of less than about 0.250 have been determined to exhibit sufficiently high oxidation resistant properties and sufficiently high electrical conductivity that they may be included advantageously in cathodes of primary zinc/nickel oxyhydroxide cells. Desirably the Raman defect ratio of the oxidation resistant graphite is between about 0.050 and 0.250, reflecting the high crystallinity of the graphite. Desirably the oxidation resistant graphite has a Raman defect ratio of between about 0.075 and 0.235. In one aspect the average particle size of the NiOOH particles in the anode of the zinc/nickel oxyhydroxide cell have an average particle size typically between about 5 and 30 micron, preferably between about 5 and 20 micron, though higher or lower NiOOH particle sizes are also possible, for example, between about 2 and 50 micron. Desirably, the oxidation resistant graphite having the above Raman defect ratio of less than about 0.250, for example, between about 0.075 and 0.235 also has an average graphite particle size about the same and even somewhat smaller than that of the NiOOH particles. It can be particularly desirable to have an oxidation resistant graphite having a Raman defect ratio between about 0.05 and 0.15. In conjunction therewith the average particle size of such oxidation resistant graphite may desirably be less than 10 micron, for example, between 1 and 10 micron.

The term “oxidation resistant graphite” as used herein is a synthetic graphite made from high purity carbon or carbonaceous materials having a highly crystalline structure. Thus, the term oxidation resistant graphite does not include true natural graphites, unless they were substantially heat treated, reprocessed and the like so that they exhibit enhanced purity and crystallinity and thus are no longer fully natural. (Some natural graphites can exhibit a Raman defect ratio less than about 0.250. However, because they were not extensively heat treated they may have an ash content greater than about 0.1 percent by weight. This could reduce the oxidation resistant properties of such graphite.) The oxidation resistant graphite preferably has an average particle size between about 1 and 50 microns, typically between about 5 and 30 microns, preferably between about 2 and 10 microns with its average particle size selected so that it is about the same or even somewhat lower, e.g. up to about 50% lower than the average particle size of the nickel oxyhydroxide particles to ensure efficient volumetric utilization of the graphite in the formation of a good percolative network resulting in good bulk conductivity of the nickel oxyhydroxide cathode.

A preferred mode of operation for the zinc/nickel oxyhydroxide cell of the invention has the total zinc-based particles in the anode comprising zinc with at least a portion of the total zinc-based particles including larger zinc particles, that is, larger than zinc fines. Although the total zinc-based particles in the anode can be comprised entirely of zinc fines or of essentially no zinc fines, it has been determined to be desirable for the total zinc-based particles in the anode to comprise a mixture of both zinc fines and larger zinc particles. Such a mixture can provide excellent overall cell performance with respect to rate capability for a broad spectrum of discharge requirements and also provide good storage characteristics for both fresh and partially discharged cells.

Another preferred mode of operation of the cell of the invention has been determined to have the total zinc-based particles in the anode comprise both at least 10 percent by weight zinc fines and also at least about 10 percent by weight of larger zinc particles. Desirably, the total zinc-based particles in the anode comprise between about 10 and 80 percent by weight zinc fines, for example, between about 30 and 70 percent by weight zinc fines, with the remainder being larger zinc particle. Cells comprising larger size zinc-based particles can exhibit less gassing when stored in the fresh un-discharged state than cells comprising 100 percent zinc fines. In this regard, the presence of larger zinc particles can serve to improve the long term storage characteristics of a cell in the fresh (i.e., non-discharged state). The zinc fines may be of 200 mesh size or smaller, that is, a size sufficiently small so that they will pass through a 200 mesh size sieve (i.e., a sieve having square openings of 0.075 mm). Preferably, the zinc fines are of 325 mesh size or smaller, that is, a size sufficiently small that they will pass through a 325 mesh size sieve (i.e., a sieve having square openings of 0.045 mm). Thus, desirably, the total zinc-based particles in the anode may comprise between about 10 and 80 percent by weight, for example, between about 30 and 70 percent by weight of −325 mesh zinc fines, with the remainder being larger zinc-based particles.

The zinc particle size distribution can appear as having a unimodal, bimodal or multimodal statistical distribution when plotted to reflect a frequency distribution versus particle size. Various modal size distributions of zinc-based particles are described in commonly assigned U.S. Pat. No. 6,521,378.

The cathode can comprise nickel oxyhydroxide, preferably in the form of a plurality of compacted slabs, disks, pellets or rings. The cathode slabs, disks, pellets or rings have a circumferential shape to match the shape of the cell housing, for example, in the case of a cylindrical housing, the cathode slabs, disks or pellets are preferably cylindrical. Each cathode slab, disk or pellet has a central hollow core running in the direction of its thickness. The resulting rings are inserted so that they are stacked one on top of another. The rings are aligned along the longitudinal axis of the cell, so that the outside surface of each ring is in contact with the inside surface of the cell housing. The stacked cathode rings include a central hollow cavity running along longitudinal axis of the cell which contains the anode. The inside surface of each cathode ring preferably is curved. Such a curved surface improves the mechanical strength of the cathode ring during transfer and handling and also provide uniform contact between the separator and the cathode. The separator is inserted into the central hollow cavity such that the outer surface of the separator abuts and closely contacts the inner surface of the cathode. A gelled anode slurry comprising zinc-based particles is added into the anode cavity such that the separator is located at the interface between the anode and the cathode. The cell end cap assembly has an elongated anode current collector, i.e., a nail, which is inserted into the anode slurry and is electrically connected to the negative terminal of the cell. The end cap assembly also includes an insulating sealing member, which electrically isolates the anode current collector from the cell housing.

Another preferred mode of operation of the cell of the invention has been determined to have a cathode including an electrically conductive additive capable of enhancing the bulk electrical conductivity of the cathode. Examples of suitable electrically conductive additives include carbon particles, nickel powder, cobalt powder, cobalt oxide, cobalt oxyhydroxide, carbon fibers, carbon nanofibers or combinations thereof. Carbon nanofibers are described, for example, in commonly assigned U.S. Ser. No. 09/658,042, filed Sep. 7, 2000 (U.S. Pat. No. 6,858,349) and U.S. Ser. No. 09/829,709, filed Apr. 10, 2001 (U.S. 2002/0172867A1). More particularly, the cathode can include between 2 wt. % and 20 wt. %, or between 5 wt. % and 15 wt. %, or between 6 wt. % and 8 wt. % of conductive carbon particles. Conductive carbon particles can include graphitized carbon, carbon black, petroleum coke or acetylene black. Preferably, the conductive carbon is a graphitized carbon. Graphitized carbon can include natural graphite, synthetic graphite, expanded graphite, graphitized carbon black or mixtures thereof. For example, conductive carbon particles can include from 10 to 90 percent by weight natural or synthetic graphite and from 90 to 10 percent by weight expanded graphite. Conductive carbon particles can have a wide variety of shapes including substantially spherical, elongated or needle-like having one dimension substantially longer than the others, flake-like having two dimensions elongated relative to a third, or fibrous or thread-like. Generally, both natural and synthetic graphite particles can have a flake-like shape.

In a primary alkaline cell including nickel oxyhydroxide as the active cathode material, it has been determined to be desirable to use a graphite that is resistant to oxidation by nickel oxyhydroxide. During storage of cells at high temperatures, nickel oxyhydroxide can attack and oxidize graphite directly. Also, the use of zinc fines (zinc particle size less than −200 mesh size) in the anode of a primary zinc/nickel oxyhydroxide cell while improving overall cell discharge performance and capacity, at high drain rates can cause an increase in the cell's internal temperature. For example, such high rate discharge of a primary zinc/nickel oxyhydroxide cell can include drain rates greater than about 2 Watts or even greater than about 1 Watt for continuous or intermittent discharge. Such an increase in the cell's internal temperature can promote direct attack and oxidation of graphite by the nickel oxyhydroxide in the cathode thereby resulting in loss of cell discharge capacity and rate capability. The use of an oxidation resistant graphite in nickel oxyhydroxide cathode reduces the rate at which graphite is attacked and oxidized directly by nickel oxyhydroxide, particularly under such conditions.

Thus, use of an oxidation resistant graphite in cathodes including nickel oxyhydroxide can minimize such undesirable processes. A suitable graphite can include from 10 to 90 wt. % oxidation-resistant graphite.

The relative oxidation resistance of a particular graphite is determined by many contributing factors. For example, it is believed that the rate of graphite oxidation is at least partially related to the specific surface area of the graphite particles whereby the smaller the surface area, the more oxidation-resistant the graphite. Similarly, oxidation resistance of a graphite can be at least partially related to the average particle size and the particle size distribution. Because larger size particles typically can have lower surface areas, they can be more oxidation-resistant. Also, oxidation resistance is believed to be at least partially related to the average crystallite size of the graphite as determined by x-ray diffraction, whereby the larger the crystallite size, the more oxidation-resistant the graphite. Further, it is believed that oxidation resistance also can depend, at least partially, on the relative number of surface defects present in the graphite particles. Specifically, the fewer the surface defects, the more oxidation-resistant the graphite. Typically, an oxidation resistant graphite can be made by heat-treating a high purity synthetic or natural graphite in an inert atmosphere at high temperatures, for example, at temperatures greater than about 2500° C. or greater than about 3000° C.

In one aspect, an alkaline primary cell includes a cathode, an anode, a separator between the anode and the cathode and an alkaline electrolyte contacting the anode and the cathode. The cathode preferably includes an oxidation-resistant graphite and an active cathode material comprising a nickel oxyhydroxide. The anode includes zinc or zinc alloy particles, of which preferably at least about 10 wt. % are 200 mesh size or smaller.

In another aspect, a method for improving discharge performance of an alkaline battery after storage at high temperatures includes providing a positive electrode including an active cathode material including nickel oxyhydroxide and a conductive additive including an oxidation-resistant graphite, providing a zinc electrode including zinc or zinc alloy particles, of which at least about 10 wt. % are 200 mesh size or smaller, and forming a cell including the cathode and anode.

A zinc/nickel oxyhydroxide cell can have improved capacity retention of discharge performance after storage at high temperature. Good performance at both high and low drain rates can be obtained by including zinc fines in the anode. By including conductive carbon particles, such as graphite, at a higher level in the cathode, the capacity of a nickel oxyhydroxide cell discharged at a low drain rate can be increased by increasing the efficiency of the cathode. More advantageously, alkaline cells can include a combination of an anode including zinc fines and a cathode including both nickel oxyhydroxide and an oxidation-resistant graphite, thereby providing very good performance characteristics after storage. Specifically, addition of zinc fines to the anode of a zinc/nickel oxyhydroxide cell can improve performance at both high and low drain rates after extended storage at high temperatures. Further, the particular combination of zinc fines in the anode with nickel oxyhydroxide and an oxidation-resistant graphite in the cathode can provide cells having improved stability during storage as well as improved discharge performance without further modifying either anode or cathode, such as by changing the compositions or by introducing other additives or dopants.

Thus, in addition to the large improvement in performance afforded by adding zinc fines to the zinc in the anode, the continuous and intermittent discharge capacities of both fresh and stored Zn/NiOOH cells of the invention are increased even further by substituting an oxidation-resistant graphite for the natural graphite in the cathode. (Preferably, the oxidation resistant graphite can also be used beneficially as a coating for the cell housing inside surface.) The combination of oxidation-resistant graphite in the cathode and zinc fines in the anode of the Zn/NiOOH cells of the invention is theorized to be particularly effective at delaying onset of polarization of the zinc anode when the Zn/NiOOH cell is discharged at high drain rates either continuously or intermittently, especially after storage for prolonged periods of time at a high temperature before discharge. That is, the delay in onset of polarization of the zinc anode, which in turn results in additional improvement of cell performance, is a direct benefit of the use in the present invention of the combination of zinc fines in the anode together with oxidation resistant graphite in the cathode. (For added benefit the cell housing inside surface may also be coated with the oxidation resistant graphite.) More specifically, the combination of use of zinc fines in the anode together with the oxidation resistant graphite in the cathode increases both continuous and intermittent discharge capacities of both fresh cells and cells which are stored for periods of time, for example, up to one year and even longer.

An improvement in overall cell performance is believed to result from an improvement in electrical conductivity between the zinc-based particles and the anode current collector. Unexpectedly, when zinc fines are included in the anode of a cell with a cathode including nickel oxyhydroxide as the active material, discharge performance under low drain conditions also was improved. An improvement in performance was obtained without substantially increasing the total design capacity of the cell. In addition, by including a relatively high level of an oxidation-resistant graphite in a cathode including nickel oxyhydroxide, improved discharge performance after storage at high temperature can be obtained. Inclusion of an oxidation-resistant graphite at a higher level either alone or in combination with other conductive additives, for example, an electrically conductive metal or a semiconductive metal oxide, such as niobium-doped tin oxide, indium-tin oxide, fluoride-doped tin oxide, fluoride-doped indium oxide, oxygen-deficient tin oxide, aluminum-doped zinc oxide, niobium-doped titanium dioxide or combinations thereof, can further improve cell performance. Specifically, the improvement in performance resulting from increasing the level of conductive additives is most apparent for continuous discharge at high drain rates.

Other features and advantages of the invention will be apparent from the description and drawing, and from the claims.

### DESCRIPTION OF DRAWING

The FIGURE is a cross-section view of a representative cylindrical alkaline cell of the invention having a cathode comprising nickel oxyhydroxide and an anode comprising zinc-based particles.

### DETAILED DESCRIPTION

Referring to the FIGURE, battery 10 includes a cathode 12 (positive electrode), an anode 14 (negative electrode), a separator 16 and a cylindrical housing 18. Battery 10 also includes current collector 20, insulating plug 22, and a negative metal end cap 24, which serves as the negative terminal for the battery. The housing 18 has a cylindrical body 49, an open end 25 and an opposing closed end 45. An end cap assembly 50 is inserted into the open end 25 of housing 18. The peripheral edge 46 of housing 18 is crimped over a portion of end cap assembly 50 thereby closing said open end. The end cap assembly 50 comprises an insulating plug 22, current collector 20, negative end cap 24, and a metal support disk 60 between end cap 24 and insulating plug 22. Current collector 20 is inserted through a central opening in the insulating plug 22 and the top end 20a of the current collector is welded to end cap 60. As end cap assembly 50 is inserted into the housing open end 25, the current collector tip end 20b penetrates into anode 14. The housing peripheral edge 46 is crimped over the edge of metal support disk 60 with the peripheral edge of insulating plug 22 therebetween. The end cap assembly 50 thus becomes firmly secured to the housing with support disk 60 in radial compression. The end cap 24 is insulated from housing 18 by a paper or plastic washer 30. End cap 24 is in electrical contact with anode 14 through anode current collector 20 and thus forms the cell's negative terminal. The cathode 12 is in contact with the housing 18 and a portion of the housing, typically at the bottom closed end thereof, forms the positive terminal 40. Insulating plug 22 is a plastic member preferably containing a rupturable diaphragm or membrane (not shown) integrally formed therein as described, for example, in U.S. Pat. No. 3,617,386. The membrane forms a thin region within insulating plug 22 and is designed to rupture should gas within the cell rise to a high level, for example, above about 100 psig, typically between about 200 and 500 psig.

Cathode 12 has an annular structure with an outer surface in electrical contact with the inner surface of housing 18, which also serves as the cathode current collector and the positive external battery terminal. Cathode 12 can include an active cathode material, conductive carbon particles, and electrolyte solution. Optionally, cathode 12 also can include an oxidative additive, a binder or both. Cathode 12 can be formed by stacking multiple smaller slabs, disks, pellets or rings 12a which can be die cast or compression molded. Alternatively, cathode 12 can be formed by extrusion through a nozzle to form a single continuous cathode 12 having a hollow core. Cathode 12 can also be formed of a plurality of rings 12a with hollow core, wherein each ring is extruded into housing 18.

An electrolytic solution is dispersed throughout battery 10. Battery 10 can be, for example, an AA, AAA, AAAA, C or D size cylindrical battery. Alternatively, battery 10 can be a prismatic, laminar or thin battery, or a coin or button cell.

Anode 14 can be formed of any of the zinc-based materials conventionally used in zinc battery anodes. For example, anode 14 can be a zinc slurry that can include zinc or zinc alloy particles, a gelling agent, and minor amounts of additives, such as a gassing inhibitor. In addition, a portion of the electrolyte solution can be dispersed throughout the anode. The zinc-based particles can be any of the zinc-based particles conventionally used in zinc slurry anodes. The anode can include, for example, between 60 wt. % and 80 wt. %, between 63 wt. % and 75 wt. %, or between 67 wt. % and 71 wt. % of zinc-based particles. The zinc-based particles can be small size zinc-based particles, such as zinc fines or zinc dust. A zinc-based particle can be formed of, for example, zinc or a zinc alloy. Preferred zinc-based particles are essentially both mercury-free and lead-free. Metals that can be alloyed with zinc to provide zinc-based particles preferably include those that can inhibit gassing, such as indium, bismuth, aluminum, and mixtures thereof. As used herein, gassing refers to the evolution of hydrogen gas resulting from a reaction of zinc metal with the electrolyte. The presence of hydrogen gas inside a sealed battery is undesirable because a pressure buildup can cause leakage of electrolyte. Generally, a zinc-based particle formed of a zinc alloy is greater than 75 wt. % zinc, typically greater than 99.9 wt. % zinc. The term zinc or zinc powder as used herein shall be understood to include zinc alloy powder which comprises a high concentration of zinc and as such functions electrochemically essentially as pure zinc.

Anode 14 preferably includes zinc fines which are mixed with zinc-based particles having a larger average particle size. One convenient measure of the amount of zinc fines in the total zinc particles is the percentage by weight of the total zinc particles which pass through a sieve of 200 mesh size. Thus, as used herein “zinc fines” are zinc-based particles small enough to pass through a 200 mesh sieve. The reference mesh size is a Tyler standard mesh size commonly used in the industry and corresponds to a U.S. Standard sieve having a square 0.075 mm opening. (Tables are available to convert a specific Tyler mesh sizes to square openings in millimeters as reported in the U.S.A. Standard Screen Specification ASTME—11 specification.) The following is an abbreviated conversion table.

TABLE A

| Sieve - Sq. | Tyler |
|---|---|
| Opening, mm | Standard |
| 0.850 | 20 mesh |
| 0.250 | 60 mesh |
| 0.150 | 100 mesh |
| 0.106 | 150 mesh |
| 0.075 | 200 mesh |
| 0.063 | 250 mesh |
| 0.045 | 325 mesh |
| 0.038 | 400 mesh |

The anode preferably comprises zinc fines which can be admixed with zinc-based particles of larger average particle size. Thus, in one aspect, the anode desirably includes at least 10 wt %, at least 15 wt %, at least 30 wt %, or at least 80 wt %, typically between 35 and 75 wt % of the total zinc or zinc alloy particles small enough to pass through a −200 mesh screen. Such zinc fines typically can have a mean average particle size between about 1 and 75 microns, for example, about 75 microns.

Even very small amounts of zinc or zinc alloy particles, for example, at least about 5 wt. % or even at least about 1 wt. % of the total zinc or zinc alloy particles which are small enough to pass through a −200 mesh screen, can produce a beneficial effect on performance of the zinc anode. (A 200 mesh size corresponds to a sieve having square openings of 0.075 mm.) Thus, as used herein “zinc fines” are zinc particles small enough to pass through a sieve of 200 mesh size. At least 25 wt. %, for example, at least 50 wt. % of the zinc or zinc alloy particles can be of larger size (−20/+200 mesh), that is, so that they will pass through a sieve between about 20 and 200 mesh size (sieve square opening of between about 0.850 mm and 0.075 mm). For example, when the total zinc in the anode comprises 10 wt. % zinc fines (batch 1) of −200 mesh size mixed with 90 wt. % larger size zinc particles (batch 2) between −20 and +200 mesh size, the mean average particle size of the total zinc particles can, for example, be about 340 microns. When the total zinc in the anode comprises 50 wt. % zinc fines (batch 1) of −200 mesh size mixed with 50 wt. % larger size zinc particles (batch 2) of between −20 and +200 mesh size, the mean average particle size of the total zinc particles can, for example, be about 200 microns. When the total zinc in the anode comprises 100 wt. % zinc fines of −200 mesh size, the mean average particle size of the total zinc particles can, for example, be about 75 microns. However, the −200 mesh zinc fines of the anodes of the cells of the present invention, also can have a broader mean average particle size, for example, between about 1 and 75 microns.

It will be appreciated that although the zinc fines preferably can form a portion of the total zinc-based particles in the anode, this is not intended to exclude the possibility that a portion of the total zinc-based particles can be present in the form of agglomerated zinc particles with or without zinc fines being present. Such agglomerated zinc-based particles are disclosed in commonly assigned U.S. Pat. No. 6,300,011.

In another aspect, at least about 10 wt. %, at least 45 wt. %, or at least 80 wt. % of the zinc or zinc alloy particles can pass through a sieve of 325 mesh size (sieve square opening of 0.045 mm). (The mean average particle size of a batch of zinc-based particles capable of passing through a 325 mesh size sieve can typically be between about 1 and 35 micron, for example, about 35 micron. Thus, it should be appreciated that a portion of such batch may be comprised of some very small zinc-based particles in the range from 1 to 35 micron, for example between about 5 and 35 micron, for example, between about 5 and 25 micron size.) Even very small amounts, for example, at least about 5 wt. % or even at least about 1 wt. % of the total zinc or zinc alloy particles which are small enough to pass through a 325 mesh size screen, can produce a beneficial effect on the performance of cells having cathodes including nickel oxyhydroxide. At least 25 wt. %, for example at least 50 wt. % of the zinc or zinc alloy particles can be larger, for example, so that they will pass through a sieve between about 20 and 200 mesh size (sieve square opening of between about 0.850 mm and 0.075 mm). For example, when the total zinc-based particles in the anode comprises 10 wt. % zinc fines (batch 1) of −325 mesh size mixed with 90 wt. % larger size zinc particles (batch 2) between 20 and 200 mesh size, the mean average particle size of the total zinc particles may for example, be about 314 microns. (The mean average particle size of the −325 mesh zinc fines may typically be between about 1 and 35 micron.) When the total zinc-based particles in the anode comprises 50 wt. % zinc fines (batch 1) of 325 mesh size mixed with 50 wt. % larger size zinc particles (batch 2) of between 20 and 200 mesh size, the mean average particle size of the total zinc particles can, for example, be about 125 microns. When the total zinc-based particles in the anode comprises 70 wt. % zinc fines (batch 1) of −325 mesh size mixed with 30 wt. % larger size zinc particles (batch 2) of between 20 and 200 mesh size, the mean average particle size of the total zinc-based particles can, for example, be about 50 microns. When the total zinc-based particles in the anode comprises 100 wt. % zinc fines of −325 mesh size, the mean average particle size of the total zinc-based particles may typically be between about 1 and 35 micron, for example, about 35 microns.

Particle size as reported herein shall be construed as determined by the more common method employed currently in the art for determining particle size, namely, by laser diffraction and using the Fraunhofer algorithm for computing the volume distribution of particle sizes and the corresponding mean average. The term average particle size as used herein and in the claims, unless otherwise specified, shall be understood to be the mean average based on a distribution of particle size versus volume percent. The laser diffraction method is described, for example, by M. Puckhaber and S. Rothele, in “Laser Diffraction—Millennium Link for Particle Size Analysis”, Powder Handling and Processing, Vol. 11, No. 1, January/March 1999. This method measures particle size in terms of a mapped spherical equivalent. For example, in the case of an acicular shaped particle, the mapped sphere can be visualized as the sphere resulting from the particle being rotated around its central axis which is at the center of and perpendicular to the long side of the particle.

Another, somewhat less accurate, traditional method for determining particle size is the sieve method. A graphical plot of particle size, y, versus cumulative volume percent, x, can be obtained from passing the total particle mixture through a series of stacked sieves so that the sieve having the largest openings (smaller mesh size) is at the top and sieves having progressively smaller openings (larger mesh size) are located towards the bottom of the stack. The volume percent, x, of particles retained between each pair of sieves is computed and associated with an average particle size, y, determined by the screen sizes. The mean average particle size can be calculated as an integral y(dx)/100, that is, the area under the plot divided by the base, 100 volume percent. Because of better accuracy and more common usage, the average particle size reported herein is that determined using the laser diffraction method.

The zinc or zinc alloy particles can be generally acicular, defined herein as having a length along a major axis at least two times a length along a minor axis. The zinc-based particles also can be generally flake-like, each flake generally having a thickness of no more than about 20 percent of the maximum linear dimension of the particle. The inclusion of such zinc fines in the anode of the cell of the invention has been determined to improve cell performance at both high and low drain rates.

Anode 14 typically can have total mercury content less than about 100 parts per million parts (ppm) of zinc by weight, preferably less than 50 parts mercury per million parts of zinc by weight. Also, the anode preferably does not contain any added amounts of lead and thus is essentially lead-free, that is, the total lead content is less than 30 ppm, desirably less than 15 ppm of the total zinc in the anode. The anode typically can include aqueous KOH electrolyte solution, a gelling agent (e.g., an acrylic acid copolymer available under the tradename CARBOPOL C940 from B.F. Goodrich), and surfactants (e.g., organic phosphate ester-based surfactants available under the tradename GAFAC RA600 from Rhöne Poulenc). Such an anode composition is presented only as an illustrative example and is not intended to restrict the present invention.

Cathode 12 can include nickel oxyhydroxide (NiOOH) as the active cathode material, conductive carbon particles, including graphite, and alkaline electrolyte solution. Optionally, the cathode also can include an oxidizing additive, a binder, or combinations thereof. Generally, the cathode can include, for example, between 60 wt. % and 97 wt. %, between 80 wt. % and 95 wt. %, or between 85 wt. % and 90 wt. % of nickel oxyhydroxide. Optionally, cathode 12 can include an admixture of two or more active cathode materials, for example, a mixture of nickel oxyhydroxide and gamma-manganese dioxide (i.e., electrolytically produced manganese dioxide or chemically produced manganese dioxide) as disclosed for example, in U.S. Pat. No. 6,566,009.

The basic electrochemical discharge reaction at the cathode can involve reduction of nickel oxyhydroxide according to the following representative reaction. However, it will be appreciated that other secondary reactions are possible as well:
NiOOH+H₂O+1e⁻→Ni(OH)₂+OH⁻ (Eq. 1)

The nickel oxyhydroxide can be prepared by a variety of synthetic methods. For example, nickel oxyhydroxide can be prepared by manually or mechanically mixing nickel hydroxide and an alkali hydroxide salt in a dry, air-free atmosphere to form a mixture. The mixture can be exposed to ozone gas at a temperature between 10 and 80° C. or between 15 and 50° C. in a suitable reaction vessel as disclosed in U.S. Pat. No. 7,081,319, which is incorporated by reference in its entirety, to form a nickel oxyhydroxide. The ozone gas can be mixed with oxygen gas and can include sufficient water vapor to initiate the oxidation process. Excessive amounts of water vapor in the gas mixture must be avoided to minimize agglomeration of the nickel hydroxide and alkali metal hydroxide powders. The mixture can be exposed to ozone gas for less than twelve hours, for example, less than six hours or less than four hours, to produce a nickel oxyhydroxide containing little or no un-reacted nickel hydroxide.

The nickel hydroxide also can be oxidized to nickel oxyhydroxide by a variety of solution-based oxidation methods including, for example, treatment with a basic aqueous solution of sodium or potassium hypochlorite or an aqueous solution of sodium or potassium peroxydisulfate. Nickel hydroxide also can be oxidized to nickel oxyhydroxide electrolytically in an aqueous solution of an alkali metal halide salt as disclosed, for example, in U.S. Patent Publication No. US 2003/0186125 A1.

A suitable nickel hydroxide can consist of particles that are approximately spherical in shape (i.e., the outer surfaces of the particles approximate spheres, spheroids or ellipsoids). The nickel hydroxide can include a beta-nickel hydroxide, a cobalt hydroxide-coated beta-nickel hydroxide, an alpha-nickel hydroxide, a cobalt hydroxide-coated alpha-nickel hydroxide and mixtures thereof. Suitable nickel hydroxides can be obtained from, for example, H. C. Starck GmbH & Co. (Goslar, Germany), Tanaka Chemical Co. (Fukui, Japan), Kansai Catalyst Co., Ltd. (Osaka, Japan) and Umicore Canada Inc. (Leduc, Alberta).

The cathode active material can include one or more nickel oxyhydroxides. The nickel oxyhydroxide can be selected from a beta-nickel(+3) oxyhydroxide, a cobalt(+3) oxyhydroxide-coated beta-nickel(+3) oxyhydroxide, a gamma-nickel(+3,+4) oxyhydroxide, a cobalt(+3) oxyhydroxide-coated gamma-nickel(+3,+4) oxyhydroxide, a solid solution of beta-nickel(+3) oxyhydroxide and gamma-nickel(+3,+4) oxyhydroxide or a cobalt(+3) oxyhydroxide-coated solid solution of beta-nickel(+3) oxyhydroxide and gamma-nickel(+3,+4) oxyhydroxide and mixtures thereof. Cobalt oxyhydroxide-coated nickel oxyhydroxide particles can include a cobalt oxyhydroxide coating that can enhance inter-particle electrical contact between nickel oxyhydroxide particles in the cathode. The cobalt oxyhydroxide coating can cover, for example, at least 60%, at least 70%, at least 80% or at least 90% of the surface of the nickel oxyhydroxide particles. Cobalt oxyhydroxide-coated nickel oxyhydroxide can be prepared from nickel hydroxide coated with between 2% and 15% by weight, between 3% and 10% by weight or between 4% and 6% by weight of cobalt hydroxide. The cobalt oxyhydroxide coating can include an optional dopant. The dopant can be selected from sodium, magnesium, calcium, strontium, barium, scandium, yttrium, lanthanum, rare earth elements, titanium, zirconium, hafnium, chromium, manganese, nickel, copper, silver, zinc, cadmium, aluminum, gallium, indium, bismuth or combinations thereof. The nickel oxyhydroxide also can include an optional bulk dopant, typically in a solid solution. The bulk dopant can be selected from aluminum, manganese, cobalt, zinc, gallium, indium or combinations thereof. The bulk dopant can be present at a relative weight percentage of less than 10%, less than 5% or less than 2%.

The nickel oxyhydroxide can consist of particles that are approximately spherical in shape (i.e., the outer surfaces of the particles approximate spheres, spheroids or ellipsoids). Preferably, the nickel oxyhydroxide includes essentially non-fractured spherical particles. The nickel oxyhydroxide can have mean average particle sizes ranging from, for example, 2 to 50 microns, 5 to 30 microns, 10 to 25 microns or 15 to 20 microns. Suitable commercial beta-nickel oxyhydroxides and cobalt oxyhydroxide-coated beta-nickel oxyhydroxides can be obtained from, for example, Kansai Catalyst Co. (Osaka, Japan), Tanaka Chemical Co. (Fukui, Japan), H.C. Starck GmbH & Co. (Goslar, Germany), or Umicore-Canada Inc., (Sherwood Park, Alberta).

Cathode 12 can include an optional oxidizing additive. Such an additive is reduced more readily than the nickel oxyhydroxide and can serve as a sacrificial additive. That is, the oxidizing additive can help to stabilize the nickel oxyhydroxide and improve the storage characteristics of the cell. Examples of oxidizing additives include sodium hypochlorite, sodium peroxydisulfate, potassium peroxydisulfate, potassium ferrate, potassium permanganate, barium permanganate, barium ferrate, silver permanganate, potassium bismuthate, silver bismuthate, and silver oxide.

Cathode 12 can include an optional binder. Examples of suitable binders include polymers such as polyethylene, polypropylene, polyacrylamide, or a fluorocarbon resin, for example, polyvinylidene difluoride or polytetrafluoroethylene. A suitable polyethylene binder is sold under the trade name COATHYLENE HA-1681 (available from Hoechst). The cathode can include, for example, between 0.05% and 5% by weight or between 0.1% and 2% by weight of binder. A portion of the electrolyte solution can be dispersed throughout cathode 12, and the weight percentages provided above and below are determined after the electrolyte solution has been so dispersed.

Cathode 12 can include conductive carbon particles, which can be present in an admixture with nickel oxyhydroxide to improve bulk electrical conductivity of the cathode. More particularly, the cathode can include between 2 wt. % and 12 wt. % or between 4 wt. % and 10 wt. % or between 6 wt. % and 8 wt. % of conductive carbon particles. Conductive carbon particles can include graphitized carbon, carbon black, petroleum coke or acetylene black. Preferred conductive carbon particles are highly graphitized. Graphitized carbon can include natural graphite, synthetic graphite, expanded graphite, graphitized carbon black or a mixture thereof. The natural or synthetic graphite can be an oxidation-resistant graphite. Preferably, the conductive carbon particles comprise from 10 to 100 percent by weight, for example between about 10 and 90 percent by weight oxidation-resistant graphite. Graphitized carbon can include graphitic carbon nanofibers alone or in an admixture with natural, synthetic or expanded graphite. Such mixtures are intended to be illustrative and are not intended to restrict the invention.

It has been determined that an oxidation resistant graphite can be included advantageously as a conductive additive in cathodes of the primary (i.e., non-rechargeable) zinc/nickel oxyhydroxide cell of the invention. Such a cell as described herein is non-rechargeable and comprises zinc particles in the anode and nickel oxyhydroxide in the cathode. In particular, it has been determined to be desirable to employ an oxidation resistant graphite as a conductive additive in the cathodes of such primary cells when the anode also includes zinc fines. The zinc fines as described herein are zinc particles that have dimensions suitable to pass through a standard 200 mesh screen. They may also include even smaller zinc particles, for example, those that pass through a 325 mesh screen.

Oxidation resistant graphite has been included as a conductive additive in the positive electrode of rechargeable nickel-cadmium (Ni—Cd), rechargeable nickel metal hydride (Ni-MH) cells, and rechargeable Ni—Zn cells. Such rechargeable cells may have pasted positive electrodes as disclosed in U.S. Pat. Nos. 5,500,309; 5,451,475; 6,210,833; 6,617,072 and 7,172,835. During electrochemical charging of the Ni-MH, Ni—Cd, and Ni—Zn cell, beta-nickel hydroxide (Ni(OH)₂) in the discharged positive electrode is oxidized to beta-nickel oxyhydroxide (NiOOH) according to Eq. 2. During charging of such rechargeable cells, side reactions can take place as shown in Eq. 3 whereby oxygen gas can be evolved. Such side reactions can occur at an increasing rate as over-charging of the positive electrode of the Ni—Cd or Ni-MH rechargeable cells produces elevated temperatures within the cell.
Ni(OH)₂+OH⁻→NiOOH+H₂O+e⁻ (Eq. 2)
2OH⁻→H₂O+½O₂+2e⁻ (Eq. 3)

It is theorized that the evolved oxygen gas (Eq. 3) in such rechargeable cells could also promote oxidation of graphite to produce carbon dioxide (CO₂) as shown in Eq. 4.
C+O₂→CO₂ (Eq. 4)
CO₂+2KOH→K₂CO₃+H₂O (Eq. 5)

In the case of a sealed rechargeable Ni—Zn cell, carbon dioxide generated by oxidation of graphite (Eq. 4) can dissolve in the alkaline electrolyte to form carbonate ions according to Eq. 5. An increase in carbonate ions in the electrolyte can produce a decrease in the ionic conductivity of the electrolyte resulting in acceleration of the rate of passivation of the zinc and consequent degradation of cell performance (See, for example, Y. Sato et al., J. Electrochemical Soc., Vol. 118, No. 8, pp 1269-1272, 1971).

In the case of a primary zinc/nickel oxyhydroxide cell there is no charging of the cell and accordingly the need for oxidation resistant graphite in the cathode is not apparent. (Oxidation resistant graphite is more expensive than more conventional natural or synthetic graphites or carbon black and thus would not normally be selected as a conductive additive in a primary cell.) It has been determined herein that cell performance of a zinc/nickel oxyhydroxide primary cell can be noticeably improved when zinc fines are employed in the anode of such cell and an oxidation resistant graphite is also included as a conductive additive in the cathode.

It is believed that in the case of a zinc/nickel oxyhydroxide primary cell, the nickel oxyhydroxide in the cathode can also promote oxidation of water in the alkaline electrolyte during storage of the cell, particularly at elevated temperature storage conditions, according to Eq. 6.1.
2NiOOH+H₂O→2Ni(OH)₂+½O₂ (Eq. 6.1)
4NiOOH+C+H₂O+2KOH→4Ni(OH)₂+K₂CO₃ (Eq. 6.2)

During storage of a zinc/nickel oxyhydroxide primary cell at elevated temperatures, for example, at 60° C., it is further believed that nickel oxyhydroxide can directly attack and oxidize graphite in the cathode according to the reaction in Eq. 6.2. Under such conditions it may also be possible for the NiOOH to directly attack and oxidize a conductive carbon coating applied to the inside surface of the cell casing. Attack and oxidation of the graphite and the conductive carbon directly by NiOOH as in Eq. 6.2 is highly undesirable, since it can result in decreased cathode conductivity and increased electrical resistance between the cathode and the cell casing which serves as cathode current collector, and can in turn adversely affect cell discharge performance and capacity. It is not apparent that such a reaction involving direct attack by NiOOH of the carbon in graphite according to Eq. 6.2 can occur in a cell not undergoing charging.

If an oxidation resistant graphite is not employed, the high oxidation potential of nickel oxyhydroxide thus could attack the graphite directly allowing the reaction in Eq. 6.2 to proceed, regardless of whether zinc fines are included in the anode. It is thus believed advantageous to add an oxidation resistant graphite to cathodes of primary (non rechargeable) zinc/oxyhydroxide cells irrespective of whether zinc fines are included. It is believed that the highly crystalline nature of the oxidation resistant graphite makes it unlikely that the reaction in Eq. 6.2 proceed at any significant rate, even at elevated temperatures.

In a preferred embodiment of the zinc/nickel oxyhydroxide primary cell of the invention, zinc fines are desirably included in the anode. The performance advantages of including zinc fines are described herein and in commonly assigned parent application, now U.S. Pat. No. 6,991,875 B2. The addition of “zinc fines” to the anode of a zinc/nickel oxyhydroxide primary cell allows the cell to be discharged at higher drain rates (either at constant or intermittent current) for a longer period than if zinc fines were not included. But discharge at higher drain rates can result in an increase in the cell's internal temperature. Such an increase in internal temperature can in turn promote direct attack and oxidation of the graphite by the nickel oxyhydroxide in the cathode, e.g. according to Eq. 6.2, thereby resulting in a loss of cell capacity and rate capability. The use of an oxidation resistant graphite in a nickel oxyhydroxide cathode can reduce the rate at which graphite is attacked or oxidized directly by the nickel oxyhydroxide. The highly crystalline nature of the oxidation resistant graphite renders it less prone to direct attack by nickel oxyhydroxide.

In sum, direct oxidation of water in the electrolyte by nickel oxyhydroxide and direct attack on and oxidation of graphite by nickel oxyhydroxide represent parasitic cathode self-discharge process in zinc/nickel oxyhydroxide cells. Such processes can result in decreased performance and capacity, especially after cell storage at elevated temperature. Use of an oxidation-resistant graphite in cathodes of a zinc/nickel oxyhydroxide primary (nonrechargeable) cell can minimize the chance of undesirable self-discharge processes thereby improving post-storage performance of cells. Desirably, the graphite can include from 10 to 100 wt. % of an oxidation-resistant graphite.

Selection of Oxidation Resistant Graphite for Use in Primary Zinc/Nickel Oxyhydroxide Cells

A graphitic carbon or graphite is normally added to cathodes of alkaline cells to improved bulk cathode conductivity. A graphitic carbon has the characteristics of an ordered three-dimensional graphite crystalline structure consisting of layers of hexagonally arranged carbon atoms stacked parallel to each other as determined by X-ray diffraction. As defined by the International Committee for Characterization and Terminology of Carbon (ICCTC) (See, for example, Carbon, Vol. 20, p 445 1982), a graphitic carbon embraces the varieties of substances consisting of elemental carbon in the allotropic form of graphite irrespective of structural defects. It has been determined to be desirable to include a graphite having oxidation resistant properties in the cathodes of a primary zinc/nickel oxyhydroxide cell. There are several parameters which can be considered in selecting graphites having suitable oxidation resistant properties and other properties making such graphites particularly desirable for inclusion in the cathodes of such cells.

Ideally, the graphite should be sufficiently oxidation resistant that is not attacked or oxidized by nickel oxyhydroxide under extreme operating conditions. For a primary zinc/nickel oxyhydroxide cell it has been determined that conditions which make conventional graphite vunerable to oxidation by NiOOH may occur, for example, when the cell is stored for prolonged periods under elevated temperature conditions. Also a primary zinc/nickel oxyhydroxide cell with zinc fines added to the anode could be vulnerable to direct oxidation of conventional graphite by NiOOH when the cell is discharged for prolonged periods at the higher drain rates enabled by the presence of zinc fines in the anode. Under such conditions, the cell's internal temperature could possibly increase sufficiently to cause direct attack and oxidation of graphite by NiOOH. Oxidation of graphite in such instances can reduce cathode conductivity and adversely affect cell performance and capacity. Thus, an oxidation resistant graphite should be included in the cathode of a zinc/nickel oxyhydroxide cell to minimize degradation of cell performance.

It is believed that the rate of graphite oxidation is at least partially related to the specific surface area (i.e., calculated from the adsoption isotherm for nitrogen gas at 77K using the Brunauer-Emmett-Teller (B.E.T.) equation) of the graphite particles whereby the smaller the specific surface area, the more oxidation-resistant the graphite. Suitable oxidation-resistant graphites can have a specific surface area less than about 20 m²/g, preferably less than about 15 m²/g, and more preferably less than about 10 m2/g, for example, between about 1 and 20 m²/g. Oxidation resistance of a graphite also can be at least partially related to the average particle size as well as the particle size distribution. Because larger size graphite particles typically can have lower surface areas, they can be more oxidation-resistant. Thus, graphite having a greater fraction of larger particle sizes will also be more oxidation resistant than the same graphite having a smaller fraction of larger particles. (Note: Other materials, for example, manganese dioxide typically having a BET specific surface area not noticeably affected by particle size or particle size distribution, since typically about 99% of the surface area of the manganese dioxide particles is due to internal porosity. However, the average particle size of the graphite should be sufficiently small to form an effective percolative network inside the cathode, whereby the graphite particles can be in intimate contact with the nickel oxyhydroxide particles, other graphite particles, and ultimately the cathode current collector.

The effectiveness of percolative network formation in the cathode by a conductive carbon additive can be increased by decreasing the mean average particle size of the conductive carbon particles (i.e., a mean average particle size equal to or less than that of particles of the cathode active material), by increasing the aspect ratio of the conductive carbon particles (i.e., more plate-like or needle-like in shape), and by increasing the degree of graphitization. In particular, in order to achieve a suitable percolative network, the mean average particle size of oxidation resistant graphite, irrespective of particle shape, is desirably about the same and preferably even somewhat smaller than the mean average size of the nickel oxyhydroxide particles. An oxidation-resistant graphite thus desirably has an average particle size between about 1 and 30 microns, preferably between about 2 and 20 microns, more preferably between about 5 and 10 microns so that its average particle size is comparable or even somewhat less than the NiOOH average particle size, which is typically between about 5 and 30 microns.

Apart from specific surface area and average particle size, it is also believed that oxidation resistance of a graphite is at least partially related to its average crystallite size. Graphite is known to consist of two distinct crystallographic phases, a hexagonal phase and a rhombohedral phase. The hexagonal phase is thermodynamically more stable than the rhombohedral phase and thus, the predominant form for both natural and synthetic graphite. The crystal structure of the hexagonal phase is composed of individual unit cells having hexagonal symmetry. The base of the hexagonal unit cell has sides that are equal in length and separated by 120° that defines a plane and in turn, the “a” axis direction of the graphite crystal structure. This basal plane contains carbon atoms bonded to each other in hexagonal arrays to form extended graphene planes that are stacked to form the overall graphite crystal structure. The height of the hexagonal unit cell in the direction of the “c” crystal axis corresponds to the perpendicular distance between equivalent basal planes of the unit cell as well as twice the distance between the adjacent graphene layers. Thus, the crystallite size is defined as the repeat distance of the hexagonal unit cell along the “a” and “c” crystal axis directions. Although the unit cell parameters for a particular type of graphite are constant, the number of unit cells along the “a” and “c” crystal axis directions can vary. Thus, the average crystallite size for a particular graphite can be defined in terms of a distance, Lₐ, corresponding to the number of repeats of the unit cell in the “a” axis direction, and a distance, L_{c}, corresponding to the number of repeats of the unit cell in the “c” axis direction. The values for the unit cell parameters, “a” and “c”, and the average crystallite sizes L_{c} and Lₐ can be determined from x-ray powder diffraction patterns. Average values for the “c” unit cell parameter and the average crystallite size, L_{c}, along the c axis direction can be calculated from the position of the 002 Bragg diffraction peak using the standard Debye-Scherrer equation. The interlayer spacing, c/2, is the distance between adjacent graphene planes and can be used as an indicator of the degree of graphite crystallinity. As the interlayer spacing approaches the value of an ideal graphite crystal (viz., 0.3354 nm), the degree of crystallinity increases. An oxidation-resistant graphite suitably can have an interlayer spacing ranging from about 0.3355 nm to 0.3358 nm. Average values for the “a” unit cell parameter and the crystallite size, Lₐ can be calculated from the position of the 100 Bragg diffraction peak using the Warren-Bodenstein equation (See, for example, B. E. Warren, P. Bodenstein, Acta Crystal., Vol. 20, p. 602, 1966). Typical average crystallite sizes Lₐ and L_{c} calculated from x-ray diffraction patterns for a natural graphite can range from about 100 nm to 300 nm. A minimum crystallite size, Lₐ greater than about 10 nm to 30 nm is needed to ensure adequate bulk cathode conductivity. It is believed that the larger the average crystallite sizes, L_{c} and Lₐ, the more oxidation resistant the graphite. Suitable oxidation-resistant graphites can have an average crystallite size along the a-axis direction, Lₐ, of greater than about 150 nm and along the c axis direction, L_{c}, of greater than about 100 nm. An average crystallite size, Lₐ greater than about 200 nm and L_{c} greater than about 150 nm is more desirable.

Further, it is believed that oxidation resistance can depend at least partially on the relative number of surface defects or dislocations present in the graphite particles. Raman spectroscopy has been used previously in the art to detect the presence of defects near the surface of graphite particles owing to a typical laser beam penetration depth of up to several hundred nanometers. It has been determined by the Applicants that the Raman defect ratio is a useful parameter for predicting whether a particular graphite will exhibit good oxidation resistance in the presence of a strongly oxidizing cathode material (e.g., NiOOH) in an alkaline primary cell. The Raman defect ratio can be interpreted as a relative measure of the degree of crystal defects present within the crystalline lattice or on the surface of graphite particles and also reflects the degree of graphitization. This interpretation is discussed in more detail herein below.

Determination of Raman Defect Ratio

Laser micro-Raman spectroscopy has been used in prior art to detect the presence of surface defects, dislocations, and microstructure in carbonaceous materials, for example, graphite. A relationship between the spectral features in the Raman spectrum of a particular graphite and its crystal structure has been described by F. Tuinstra and J. L. Koenig (See, for example, J. Chem. Physics, Vol. 53, pp 1126-30, 1970). The first order laser Raman spectrum of graphitic carbons typically exhibit two absorption bands including a sharp, intense band centered at about 1570-1580 cm⁻¹ commonly referred to as the “G” band and a broader, weak band centered at about 1330 to 1360 cm⁻¹ commonly referred to as the “D” band. The “G” band is thought to correspond to a E_{2g} vibrational mode in the graphene planes. The “D” band is believed to be associated with structural disorder at the surface of the graphite particle and typically is absent for single crystal graphite. More specifically, the “D” band has been attributed to a vibrational mode originating from a distortion of the hexagonal lattice near the edges of crystallites. (See, for example, M. Nakamizo, H. Honda, M. Inagaki, Carbon, Vol. 16, No. 4, p. 281, 1978). The ratio of the normalized intensity of the “D” band to that of the “G” band can be correlated with the relative number of defects in the crystal lattice. (See, for example, J.-N. Rouzard and A. Oberlin, Carbon, Vol. 27, p. 517, 1989). Further, the ratio of the peak intensities of the “D” and “G” bands, referred to as “ᵢD” and “ᵢG” respectively, can be correlated with the average crystallite size, Lₐ, (See, for example, F. Tuinstra and J. L. Koenig, J. Chem. Phys., Vol. 53, pp 1126-1130, 1970) as given in Eq. 7.1.
Lₐ=(22.82/100)×(ᵢD/ᵢG)⁻¹ (in nanometers) (Eq. 7.1)
This relationship is valid as long as the value for Lₐ is smaller than the laser spot size (i.e., typically about 1 micron) (See, for example, H. Wilhelm et al., J. Appl. Phys., Vol. 84, No. 12, p. 6552, 1998).

Instead of using the intensities of the “D” and “G” peaks, the integrated areas of the “D” and “G” peaks were calculated using a peak-fitting algorithm that included application of both Gaussian and Lorentzian functions and the Raman defect ratio, R_{d} was calculated as the ratio of the integrated peak areas as shown in Eq. 7.2.
R_{d}=aD/aG (Eq. 7.2)
The “D” peak area (aD) typically was integrated between about 1251.4 and 1401.5 cm⁻¹ using a Gaussian function and the “G” peak area (aG) was integrated between about 1501.2 and 1652 cm⁻¹ using a Lorentzian function. The integration algorithm employed provided peak area as well as peak width, height, and location of the peak center. The Raman defect ratios listed in Table B were calculated using such integrated peak areas.

The Raman spectra for a wide variety of carbons including commercial carbon blacks, graphitized carbon blacks, natural graphites, and synthetic graphites were measured using a Renishaw Model 1000 Laser Raman spectrometer equipped with a He—Ne laser source (632.8 nm) and a single monochrometer having a 1800 lines/mm grating. Samples were measured using a 10 mW beam power intensity to obtain a spectral resolution of 3 cm⁻¹. The intensity and Raman shift of the scattered light was detected using a high resolution CCD imager. Typically, a sample of the graphite powder was deposited onto the surface of a glass slide as a thin layer and then packed down lightly with another slide to provide a smooth surface. The laser beam was focused on the surface of a single graphite particle in the sample and the spot size of the laser beam minimized. Spectrometer operational parameters were adjusted so as to maximize signal to noise ratio by selecting an appropriate attenuation filter-type. The objective magnification, beam attenuation, and data acquisition time were selected using an iterative optimization process. Spectrum scan was centered on 1450 cm⁻¹ and data collected from about 1200 to 1700 cm⁻¹.

Typically, the value of the Raman defect ratio for a highly crystalline sample of pristine synthetic graphite is about 0.050. In contrast, poorly graphitized carbons such as carbon blacks, furnace blacks, and acetylene blacks exhibit substantially greater Raman defect ratios. For example, as presented in Table B, a Shawinigan acetylene black (e.g., AB50P) having an average particle size less than 50 nm and a specific surface area of from 70 to 75 m²/g has a Raman defect ratio of about 0.470. Even the presence of a rudimentary “D” band in the Raman spectrum indicates the presence of surface defects. For example, mechanical milling or grinding of a commercial graphite powder to reduce the mean average particle size can increase the Raman defect ratio as surface disorder and lattice defects are created (See, for example, C. Natarajan, H. Fugimoto, A. Mabuchi, K. Tokumitsu, T. Kasuh, J. Power Sources, Vol. 92, p. 187, 2001). Depending on the particular grinding method used and the intensity of grinding, the level of defects and disorder can differ greatly for similar size particles (See, for example, F. Salver-Dimas et al., Mol. Cryst. Liq. Cryst., Vol. 310, pp 219-24, 1998). Thus, small particles of a particular graphite can have a larger Raman defect ratio than larger particles of the same graphite if the smaller particles were produced by mechanical milling of the larger particles. However, as determined by the Applicants herein, if the smaller size graphite particles are merely separated by a sieving process from a large batch of oxidation resistant graphite having a relatively large average particle size and a broad particle size distribution, there appears to be little if any change in the Raman defect ratio between the smaller size particles and the larger size particles separated from the same batch (See, for example, the section herein below entitled “Preparation of Graphite Samples Having Different Average Particle Sizes by Sieving”).

Significantly, it has been determined by the Applicants herein that the Raman defect ratio can be used as a principal indicator for characterizing and selecting oxidation resistant graphites which are particularly suitable for use in cathodes of primary zinc/nickel oxyhydroxide cells. In general, oxidation resistant graphites have lower Raman defect ratios for a given average particle size than other graphites such as conventional natural or synthetic graphites that are not as oxidation resistant. It has been determined that a low Raman defect ratio of less than about 0.250, for example between about 0.050 and 0.250, desirably between about 0.075 and 0.235 ensures sufficiently high degree of graphitization and accompanying oxidation resistance as well as sufficiently high electrical conductivity to make such graphites particularly suitable for addition to or inclusion in cathodes of primary zinc/nickel oxyhydroxide cells. More specifically, oxidation resistant graphite having a low Raman defect ratio of less than about 0.250, for example, between about 0.050 and 0.250, desirably between about 0.075 and 0.235, are particularly advantageously employed in cathodes of zinc/nickel oxyhydroxide primary cells wherein the graphite particles have an average particle size about the same or somewhat smaller than the mean average particle size of the NiOOH particles. The mean average particle size of the NiOOH typically included in the cathode of a zinc/nickel oxyhydroxide cell is desirably between 2 and 50 microns, typically between about 5 and 30 microns, for example, between about 5 and 20 microns. Thus, the oxidation resistant graphite preferably has an average particle size between 1 and 50 microns, typically between about 5 and 30 microns, for example between about 2 and 10 microns with its average particle size selected so that it is about the same or somewhat lower, e.g. up to about 50% lower than the average particle size of the NiOOH. This ensures efficient volumetric utilization of the graphite resulting in good percolative network formation as well as good bulk conductivity in the NiOOH cathode.

Preparation of Oxidation Resistant Graphite

Typically, an oxidation-resistant graphite can be prepared by thermal treatment of a high purity natural or synthetic graphite in an inert atmosphere (e.g., argon, helium) at very high graphitization temperatures, for example, in the range from about 2500° C. to about 3000° C. for relatively long periods of time. It is believed that treating a high purity synthetic or natural graphite at a high graphitization temperature for an extended period of time, for example, 48 hours or more, can produce a graphite having a higher degree of crystallinity, larger average crystallite size, fewer surface defects, lower specific surface area, and higher chemical purity (i.e., lower ash content) than the precursor graphite. A maximum ash content of less than about 0.1% by weight is desirable and less than about 0.05% by weight is more desirable. Furthermore, additional heat treatment at 2500° C. in a helium atmosphere of a synthetic graphite that had been mechanically milled was reported. (See, for example, M. E. Spahr et al., J. Power Sources, Vol. 119-121, pp 543-9, 2003) to anneal out most of the surface defects, thereby decreasing the Raman defect ratio. In addition, after heat treatment, crystallinity was increased substantially as reflected by a significant increase in average crystallite size, L_{c} and interlayer spacing, c/2 as well as a decrease in lattice defects such as stacking defects.

Suitable oxidation-resistant synthetic graphites which may be beneficially added to cathodes of a primary zinc/nickel oxyhydroxide cell are available commercially under the trade designation “TIMREX® SFG” from Timcal America Co. (Westlake, Ohio). The SFG-type graphites suitable for inclusion as an admixture with nickel oxyhydroxide in cathodes of cells of the present invention include TIMREX® SFG44, SFG15, SFG10, and SFG6. Preferred oxidation-resistant synthetic graphites include TIMREX® SFG10 and SFG15. The number appearing after the SFG designation refers to the d₉₀ particle size that is defined as follows: 90 volume percent of the particles have a particle size in microns less than the indicated number as determined by a laser diffraction particle sizing method. For example, SFG10 graphite has a d₉₀ particle size of about 10 microns. It should be noted that the average particle size typically can be substantially smaller. Other oxidation-resistant synthetic graphites are available under the trade designations TIMREX® SLP50 and SLX50. Further, oxidation-resistant synthetic graphites that were heat-treated again after mechanical milling having decreased surface and lattice defects are particularly preferred as oxidation resistant graphites. Such graphites are available under the trade designations TIMREX® SFG15HT, SFG6HT, and SFG4HT. Other suitable oxidation-resistant, heat-treated natural graphites are available, for example, under the trade designation 2939 APH-M from Superior Graphite (Chicago, Ill.). The lowest defect Raman defect ratios were obtained for SFG-type graphites that had been heat-treated at an elevated temperature under an inert atmosphere after mechanical milling. For example, TIMREX® SFG 15HT graphite, with an average particle size of about 10 microns, has a defect ratio that is about 50% of that of SFG 15 graphite, which had the same average particle size but was not heat-treated after milling. It is thus desirable to have an oxidation resistant graphite having a Raman defect ratio between about 0.05 and 0.15. It is particularly desirably to have such oxidation resistant graphite in conjunction with an average particle size of less than 10 micron, for example, between 1 and 10 micron, for such graphite. These oxidation resistant graphites can be made, for example, by subjecting graphites such as the SFG type graphites to additional heat treatment at very high temperature, for example, at about 2500° C. in an inert helium atmosphere.

In addition to being oxidation resistant, the graphite must be sufficiently electrically conductive to provide the needed interparticle conductivity between the nickel oxyhydroxide particles in the cathode. For example, some carbon additives including various types of graphites are known to exhibit higher electrical conductivity than others. Thus, it would not be suitable to employ a highly oxidation resistant graphite if the sacrifice in its electrical conductivity was very great compared to more conventional graphites (natural, synthetic or expanded graphites not being. particularly oxidation resistant). The graphite particle size and shape impact interparticle electrical conductivity. For example, decreasing the average particle size of certain plate-like or flaky graphite particles, for example by mechanical grinding, can result in decreased electrical conductivity for the smaller particles. Although particle shape and size are contributing factors, a principal method of increasing electrical conductivity of carbon particles is by increasing the degree of graphitization, for example, by heat treatment of a synthetic graphite or carbon black.

In the context of the primary zinc/nickel oxyhydroxide cell of the invention it has been determined desirable to add an oxidation resistant graphite to the cathode of such cell. As explained in the forgoing, direct attack of graphitic carbon by NiOOH could most likely occur during elevated temperature storage of the cell. It has been determined particularly useful to add such an oxidation resistant graphite to the cathode of a primary zinc/nickel oxyhydroxide cell to reduce the rate of such attack of graphitic carbon by the NiOOH active material in the cathode. Also, in the preferred embodiment when zinc fines are included in the anode, addition of an oxidation resistant graphite to the cathode of a primary zinc/nickel oxyhydroxide cell has been determined to be highly beneficial. As previously indicated when zinc fines are included in the anode the cell can be discharged continuously at higher drain rates for a longer period of time thereby possibly increasing the cell's internal temperature. Inclusion of an oxidation resistant graphite in the cathode of a primary zinc/nickel oxyhydroxide cell can mitigate the chance for direct attack on or rate of oxidation of graphitic carbon by NiOOH under such elevated temperature conditions.

Preparation of Graphite Samples having Different Average Particle Sizes by Sieving

Typically, synthetic or natural graphites having different average particle sizes and particle size distributions, with the same relative purity and similar degrees of graphitization are prepared by mechanical milling of a larger particle size, highly crystalline, precursor graphite powder for different periods of time. For example, a product family including various size grades of highly graphitized synthetic graphites is commercially available from Timcal America. Different grades having different mean average particle sizes can be prepared by milling (e.g., jet milling, impact milling, impingement milling) a common precursor graphite (e.g., TIMREX® SFG150) for different periods of time to obtain the desired mean average particle size. Particle sizes can range from 70 microns down to about 3 microns. However, the Raman defect ratio, of smaller size particles obtained by milling typically increased when compared to the Raman defect ratio of the precursor graphite. The crystallite size also decreased somewhat, especially for the smaller particle size products milled for extended periods of time. In order to decouple the apparent linkage between average particle size and Raman defect level produced by milling, a large sample of a graphite (e.g., TIMREX® SFG150) having a mean average particle size of about 70 microns was successively sieved through 200 mesh, 325 mesh, 400 mesh, and 500 mesh standard sieves. Five fractions of graphite powder were collected: +200; −200/+325; −325/+400; −400/+500; −500 that are referred to sequentially as “SFG150 sieve# 1-5” and have the corresponding mean average particle sizes shown in Table B. Although mean average particle sizes ranged from about 115 microns (sieve #1) to about 23 microns (sieve# 5), defect ratios were nearly identical to that for the parent TIMREX® SFG150 graphite. Typically, the defect ratio for a commercial graphite product having a mean average particle size comparable to that of a sieved graphite powder was much greater. For example, a sample of TIMREX® SFG 44 graphite with a mean average particle size of about 25 microns had a defect ratio nearly twice that of SFG 150 graphite passed through sieve # 4 with a mean average particle size of about 26 microns. Thus, it can be concluded that as the average particle size of a particular commercial graphite is reduced as by milling, surface defects are created and the defect ratio increases. However, if smaller size graphite particles are merely separated as by sieving from a batch of oxidation resistant graphite having a larger average particle size and a broad particle size distribution there appears to be little, if any, change in the Raman defect ratio between smaller size particles and the larger size particles from the same batch. Thus, graphites having the desired particle size for example between about 1 and 30 microns, preferably between about 2 and 10 microns (so that the graphite average particle size is about the same as or somewhat smaller than the preferred NiOOH average particle size) are best obtained by sieving rather than milling a batch of oxidation resistant graphite of larger average particle size.

TABLE B
Raman Defect Ratios for Various Graphite Types
and Particle Sizes

| | | Specific | Crystallite | Interlayer | R_{d} = ₐD/ | |
|---|---|---|---|---|---|---|
| | Particle | Surface | Size, | Distance, | ₐG | Std |
| Carbon Sample | Size | Area | L_{c} | c/2 | Ratio | Dev |
| Identification¹ | (d₅₀, μm) | (m²/g) | (nm) | (nm) | (ave) | (+/−) |
| GK v-cond8/99 | 8.0 | 20 | — | — | 0.5169 | 0.1300 |
| SAB AB50P | 0.042 | 70-75 | — | 0.3500 | 0.4700 | 0.0398 |
| MM179 | — | 118 | — | — | 0.4727 | 0.0444 |
| MM131 | — | 63 | — | 0.3450 | 0.3949 | 0.0122 |
| KS 4 | 2.4 | 26 | 60 | 0.3357 | 0.3144 | 0.0541 |
| KS 6 | 3.4 | 20 | 75 | 0.3357 | 0.2751 | 0.1075 |
| KS 15 | 8.0 | 12 | 90 | 0.3356 | 0.2411 | 0.0578 |
| SFG4HT | 3.1 | 16.8 | >90 | 0.3355 | 0.1300 | 0.0448 |
| SFG 6 | 3.5 | 17 | >100 | 0.3355 | 0.2742 | 0.0420 |
| SFG6HT | 4.0 | 8.2 | >150 | 0.3355 | <0.1000 | — |
| SFG 10 | 6.6 | 12.5 | >150 | 0.3355 | 0.2306 | 0.0608 |
| SFG 15 | 8.8 | 9.5 | >150 | 0.3355 | 0.2286 | 0.0367 |
| SFG 15HT | 9.9 | 4.3 | 440 | 0.3356 | 0.1249 | 0.0252 |
| SFG 44 | 24.9 | 5 | >200 | 0.3355 | 0.1709 | 0.0408 |
| SFG 75 | 35.4 | 3.5 | >200 | 0.3355 | 0.1206 | 0.0412 |
| SFG 150 | 70.6 | — | >200 | 0.3354 | 0.0682 | 0.0864 |
| SFG 150 sieve#5 | 23.3 | — | >200 | — | 0.1083 | 0.0559 |
| SFG 150 sieve#4 | 25.8 | — | >200 | — | 0.0965 | 0.0414 |
| SFG 150 sieve#3 | 57.1 | — | >200 | — | 0.1066 | 0.0723 |
| SFG 150 sieve#2 | 80.4 | — | >200 | — | 0.0527 | 0.0115 |
| SFG 150 sieve#1 | 115.3 | — | >200 | — | 0.0784 | 0.0379 |

Notes:
¹SFG, KS and MM designations represent grades of TIMREX brand graphites and graphitized carbon blacks from Timcal-America (Weslake, Ohio). SAB AB50P carbon is Shawinigan acetylene black. GK v-cond9/99 is a synthetic carbon black from Graphit Kropfmuhl AG (Hauzenburg, Germany)

Since the mean average particle size of NiOOH particles included in cathodes of a primary zinc/nickel oxyhydroxide cell is typically between about 5 and 30 microns, for example, between about 5 and 20 microns, preferably between about 5 and 15 microns, a suitable particle size for the oxidation resistant graphite particles is about the same or somewhat smaller. Thus, the average particle size of the oxidation resistant graphite is between about 1 and 50 micron, typically between about 5 and 30 micron, more preferably between about 1 and 10 micron. More typically the average particle size of an oxidation resistant graphite or other conductive carbon in the cathode is less than about 20 microns, less than about 15 microns or preferably less than about 10 microns, for example, more preferably between about 1 and 10 microns. It has been determined that a preferred range of average particle size for conductive carbons and oxidation resistant graphites in the cathode is between about 1 and 10 microns, though as above indicated it is not intended to limit the conductive particle size to this range. With reference to the list of conductive carbon particles and graphites presented in Table B, those having an average particle size less than about 10 microns include GK v-cond8/99, SAB AB50P, KS-4, KS-6, KS-15, SFG4HT, SFG6HT, SFG10, SFG15, and SFG15HT type graphites and conductive carbons. Specific surface areas of the conductive carbons (having average particle size less than 10 microns) range from about 4 m²/g to about 75 m²/g. The specific surface areas of the graphites in the latter list (i.e., excluding SAB AB50P Shawinigan acetylene black) range from 4 m²/g to about 26 m²/g. The X-ray crystallite sizes, L_{c} of the graphites selected from the latter list (average particle size less than 10 microns) range from about 60 nanometers to about 440 nanometers. Further, the interlayer distance, c/2, is nearly identical for all these listed graphites having a mean average particle size less than about 10 microns. However, the Raman defect ratio measured for the above listed graphites having average particle sizes less than about 10 microns can range from about 0.10 to about 0.52 as shown in Table B.

The preferred graphites from the list given in Table B having high oxidation resistance which are most desirable for use in cathodes of a primary zinc/nickel oxyhydroxide cell are those graphites with a Raman defect ratio of less than 0.250, for example, between about 0.050 and 0.235 and an average particle size as above indicated more preferably between about 1 and 10 microns. (It is not intended to limit the oxidation resistant graphite to this preferred range of average particle size of between 1 and 10 microns, since as above discussed a suitable average particle size for the oxidation resistant graphite may generally be about the same or somewhat smaller than that of the nickel oxyhydroxide). Thus, with reference to Table B, preferred graphites having both a Raman defect ratio less than 0.250 and an average particle size less than 10 microns include SFG4HT, SFG6HT, SFG10, SFG15, SFG15HT, and KS15, under the TIMREX® brand from Timcal America Co. These graphites all have a Raman defect ratio less than about 0.250, namely between about 0.100 (or less) and 0.240, and also an average particle size between about 1 and 10 microns.

Zn/NiOOH Primary Cells—Effect of Graphites with Low Raman Defect Ratio on Performance

To illustrate the benefit of including an oxidation resistant graphite with a low Raman defect ratio less than 0.250 in the cathode of a zinc/manganese dioxide primary cell, results from representative performance tests are presented. The cells employed cathode formulations selected from the following Table 1A and anode formulations from Table 2A.

TABLE 1A
Cathode Formulations for Additional Tests

| | Formulation | Formulation | Formulation |
|---|---|---|---|
| Component | A-1 (wt %) | B-1 (wt %) | C-1 (wt %) |
| NiOOH¹ | 85 | 85 | 85 |
| Natural graphite² | 8 | 0 | 0 |
| Synthetic Carbon | 0 | 8 | 0 |
| black | | | |
| Oxidation-resistant | 0 | 0 | 8 |
| graphite³ | | | |
| Polyethylene | 1 | 1 | 1 |
| binder⁴ | | | |
| Electrolyte | 6 | 6 | 6 |
| solution⁵ | | | |
| Notes: | | | |
| ¹NiOOH powder is primarily beta-nickel (+3) oxyhydroxide having a mean average particle size of about 19 microns. The NiOOH particles have a surface coating of cobalt oxyhydroxide in the amount of about 4 percent by weight of the pure NiOOH. | | | |
| # The total amount of active NiOOH was about 85/1.04 = 81.7 percent by weight of the cathode. Cobalt oxyhydroxide-coated beta-nickel oxyhydroxide is commercially available from Kansai Catalyst Co., Ltd. (Osaka, Japan). | | | |

²Untreated or treated natural graphites. A natural graphite with the tradename MP-0507 having an average particle size of about 7 microns, a specific surface area of about 10 m²/g, and a crystallite size, L_{c} of about 200 nm is available from Nacional de grafite (Itapecerica, MG Brazil).
³Oxidation resistant graphite or other substitute graphites having various Raman defect ratios and average particle sizes were used in cathode formulation C-1 for testing.
⁴Polyethylene binder under the trade designation “Coathylene” from Hoechst Celanese.
⁵The aqueous electrolyte solution contains 38% by weight of dissolved KOH and about 2% by weight of dissolved zinc oxide.

TABLE 2A
Anode Formulations for Additional Tests

| | Formulation | Formulation |
|---|---|---|
| Component | E (wt %) | F (wt %) |
| Large Particle Zinc¹ | 32.00 | 19.20 |
| (−20/+200 mesh) | | |
| Zinc fines² (−325 mesh) | 32.00 | 44.80 |
| Gelling agent 1³ | 0.522 | 0.522 |
| Gelling agent 2⁴ | 0.036 | 0.036 |
| Surfactant⁵ | 0.107 | 0.107 |
| Gassing inhibitor⁶ | 0.029 | 0.029 |
| Electrolyte⁷ | 35.306 | 35.306 |

Notes:
¹Zinc-based particles having a mean average particle size of about 370 microns and were alloyed and plated with indium to give a total indium content of about 350 ppm.
²Zinc-based particles having a mean average particle size of about 35 microns and were alloyed and plated with indium to give a total indium content of about 700 ppm.
³A polyacrylic acid-based gelling agent available under the tradename Carbopol 940 from B.F. Goodrich Co.
⁴A grafted starch-based gelling agent available under the tradename Waterlock A221 from Grain Processing Corp.
⁵An organic phosphate ester-based surfactant available in the form of a 3 wt % solution under the tradename RM 510 from Rhône Poulenc.
⁶Indium acetate added as an inorganic gassing inhibitor.
⁷The aqueous electrolyte solution contained 35.4% by weight of dissolved KOH and about 2% by weight of dissolved zinc oxide.

AA size test cells were fabricated having a NiOOH cathode of formulation C-1 (Table 1A) and a zinc anode of formulation E (Table 2A). As shown in Table 1A, test cells having cathode formulation C-1 included 85 wt % NiOOH, 8 wt % oxidation resistant graphite, 1 wt % polyethylene binder, and 6 wt % alkaline electrolyte solution. The test cells all had identical anodes of formulation E. AA size comparison cells were fabricated also having anodes of formulation E. The cathode formulation used for the comparison cells was essentially the same as the test cells, with the exception that graphites having Raman defect ratios less than 0.250 were used in the test cells and graphites or carbon blacks having Raman defect ratios greater than 0.250 were used in the comparison cells. Thus, the comparison cells used cathode formulation B-1 (Table 1A) with 85 wt % NiOOH and 8 wt % synthetic carbon black, 1 wt % polyethylene binder, and 6 wt % electrolyte. The average particle size of the NiOOH in all the cells was the same, namely about 19 microns, and the graphites used in the test cells and the carbon black used in the comparison cells all had an average particle size smaller than the NiOOH, namely less than about 10 microns.

Specifically, in a representative example the comparison cells having a cathode of formulation B-1 including 8 wt % synthetic carbon black (GK v-cond8/99) have an average particle size of 8 microns and Raman defect ratio of 0.52. The synthetic carbon black is available from Graphit Kropfmuhl AG (Hauzenburg, Germany). One set of test cells (No. 1) used a cathode of formulation C-1 with 8 wt % SFG 10 oxidation resistant graphite from Timcal America. Another set of test cells (No. 2) used a cathode of formulation C-1 with 8 wt % SFG 15 oxidation resistant graphite from Timcal America. All the cells used the same zinc anode namely formulation E. Comparison and test cells were fabricated and discharged fresh and after 1 week of storage at 60° C. with the performance summarized in Table C.

TABLE C
Zn/NiOOH Primary Cells
Representative Effects of Oxidation Resistant
Graphite on Cell Capacity

| | Capacity to 0.9 V | | | |
|---|---|---|---|---|
| | 1 Watt continuous discharge | | | |
| | to 0.9 Volt | | | |
| | | Stored | | |
| | | Capacity | | |
| | | after 1 | Capacity | |
| | | week | retained | Defect |
| Zn/NiOOH Cells^{1,2} | Fresh | storage at | after | Ratio of |
| (Zinc anode | Capacity | 60° C. | storage | cathode |
| formulation E) | (Watt-hrs) | (Watt-hrs) | (Percent) | carbon |
| Comparative Cell | 1.341 | 0.824 | 61.5 | 0.5169 |
| (Cathode | | | | |
| formulation B-1 - | | | | |
| synthetic carbon | | | | |
| black GK v-cond | | | | |
| 8/99) | | | | |
| Test Cell 1 | 1.648 | 1.283 | 77.9 | 0.2306 |
| (Cathode | | | | |
| formulation | | | | |
| C-1 - SFG 10 | | | | |
| oxidation resistant | | | | |
| graphite) | | | | |
| Test Cell 2 | 1.697 | 1.362 | 80.3 | 0.2286 |
| (Cathode | | | | |
| formulation | | | | |
| C-1 - SFG 15 | | | | |
| oxidation resistant | | | | |
| graphite) | | | | |

Notes:
¹NiOOH average particle size, 19 microns in both comparative and test cells.
²Carbon black in Comparative cell and oxidation resistant graphites in the Test cells had comparable average particle sizes between 1 and 10 microns.

The performance results shown in the above Table C clearly show the benefit of including an oxidation resistant graphite (viz., Raman defect ratio less than 0.250) in the cathode. Both test cells 1 and 2 including an oxidation resistant graphite provided greater capacity when discharged continuously at 1 watt until cell voltage decreased to 0.9 Volt either fresh or after 1 week storage at 60° C. than the comparative cell with a conductive carbon having a higher Raman defect ratio. Also, the percent capacity retained by the cells discharged after storage compared to fresh cells was clearly less for the comparative cell than either of the test cells.

Similar tests using the same comparative and test cells as in Table C were performed with the cells discharged intermittently at 1 Watt either fresh or after 1 week storage at 60° C. Specifically, the cells were discharged at 1 Watt for 3 seconds followed immediately by 0.1 Watt for 7 seconds and the cycle repeated until cell voltage decreased to 0.9 Volt. The test results are shown in Table D.

TABLE D
Zn/NiOOH Primary Cells
Representative Effects of Oxidation Resistant
Graphite on Cell Capacity
(Intermittent Discharge Test)

| | Capacity to 0.9 V | | | |
|---|---|---|---|---|
| | 1 Watt intermittent discharge | | | |
| | to 0.9 Volt³. | | | |
| | | Stored | | |
| | | Capacity | | |
| | | after 1 | Capacity | |
| | | week | retained | Defect |
| Zn/NiOOH Cells^{1,2} | Fresh | storage at | after | Ratio of |
| (Zinc anode | Capacity | 60° C. | storage | cathode |
| formulation E) | (Watt-hrs) | (Watt-hrs) | (Percent) | carbon |
| Comparative Cell | 2.046 | 1.222 | 59.7 | 0.5169 |
| (Cathode | | | | |
| formulation B-1 - | | | | |
| synthetic carbon | | | | |
| black GK v-cond | | | | |
| 8/99) | | | | |
| Test Cell 1 | 2.228 | 1.897 | 85.2 | 0.2306 |
| (Cathode | | | | |
| formulation C-1 - | | | | |
| SFG10 | | | | |
| oxidation resistant | | | | |
| graphite) | | | | |
| Test Cell 2 | 2.134 | 1.902 | 89.1 | 0.2286 |
| (Cathode | | | | |
| formulation C-1 - | | | | |
| SFG 15 | | | | |
| oxidation resistant | | | | |
| graphite) | | | | |

Notes:
¹NiOOH average particle size, 19 microns in both comparative and test cells.
²Carbon black in Comparative cell and oxidation resistant graphites in the Test cells had comparable average particle sizes between 1 and 10 microns.
³Cells were discharged at 1 Watt for 3 seconds followed immediately by 0.1 Watt for 7 seconds and the cycle repeated until cell voltage decreased to 0.9 Volt.

The performance results shown in the above Table D as in Table C clearly show the benefit of including an oxidation resistant graphite (viz., Raman defect ratio less than 0.250) in the cathode. Both test cells 1 and 2 including an oxidation resistant graphite provided greater capacity when discharged intermittently at 1 Watt either fresh or after 1 week storage at 60° C. than the comparative cell with a conductive carbon with a higher Raman defect ratio. Also the percent capacity retained by the cells discharged after storage compared to fresh cells was substantially lower for the comparative cells than either of the test cells.

Coating Inside Surface of Cell Housing with Oxidation Resistant Graphite

An oxidation-resistant graphite as above characterized also can be included advantageously in the conductive layer applied to the inner surface of the cell housing or casing 18. The coating formulation can include oxidation-resistant graphite particles dispersed in a one or more organic solvents or in water including a surfactant and/or dispersing aid, and a film-forming binder dissolved in the organic solvents or co-dispersed as a latex in water. The amount of oxidation-resistant graphite in the dried coating can range from 40 to 85 wt %. Suitable organic solvents can include alcohols, such as n-propanol, iso-propanol, n-butanol, iso-butanol, n-hexanol, n-heptanol, 2-butoxyethanol; ketones, such as acetone, methyl ethyl ketone (MEK), methyl iso-butyl ketone (MIBK); acetate esters, such as methyl acetate, ethyl acetate, n-butyl acetate and mixtures thereof. However, water is preferred in order to minimize the amount of volatile organic compounds (VOC) released during drying of the coated layer. Suitable film-forming polymeric binders can include, for example, a co-polymer of vinyl acetate and ethylene; vinyl acetate and vinyl chloride; styrene and butadiene; acrylonitrile, butadiene, and styrene; vinyl acetate, vinyl chloride, and ethylene; styrene and acrylic acid; a colloidal dispersion of polyurethane; epoxy resins such as Bisphenol A, Bisphenol F Epichlorohydrin or an epoxy novalac; vinyl isobutyl ether; vinyl butyral. Suitable commercial surfactants can be selected from the classes of nonionic surfactants or fluorosurfactants or mixtures of surfactants. Surfactants can function to improve the wettability of the graphite particles so as to form stable, homogeneous dispersions thereby avoiding agglomeration or flocculation of the particles and also avoiding inclusion of air or voids in the coated layer. The amount of surfactant present in the aqueous dispersion desirably can range from 0.5 to 5 wt. %. Greater amounts of surfactant would be expected to degrade the adhesion of the coated layer to the inside surface of the cell housing. Other additives, such as anti-foaming agents optionally can be included in the aqueous dispersion as required.

A continuous conductive layer including an oxidation resistant graphite can be applied to the inner surface of the cell housing by a variety of well-known coating methods as disclosed, for example, in Canadian Patent No. 1,263,697. After drying, the coated layer is electrically conductive and serves to improve electrical contact between the cathode 12 and the cell housing 18 which also serves as the cathode current collector. The coated layer containing oxidation resistant graphite also protects the metal cell housing from direct attack and oxidation by highly oxidizing cathode active materials for example, nickel oxyhydroxide and maintains good electrical conductivity between the cathode and cell housing, especially after storage at elevated temperatures or for extended periods of time at ambient temperatures, for example, up to a year, two years, five years, and even longer. Such an oxidation resistant conductive coating can also help to delay onset of cathode polarization, assuring continued good ionic mobility and thereby achieving improved overall cell performance.

### Specific Embodiments of the Zinc/Nickel Oxyhydroxide Cell

Anode 14 comprises zinc alloy powder between about 60 wt % and 80 wt %, between 62 wt % and 75 wt %, preferably between about 62 and 72 wt % of zinc particles. Preferably the zinc alloy powder comprises between about 62 to 72 wt % (99.9 wt % zinc containing indium containing 200 to 500 ppm indium as alloy and plated material), an aqueous KOH solution comprising 35.4 wt % KOH and about 2 wt % ZnO; a cross-linked acrylic acid polymer gelling agent available commercially under the tradename “CARBOPOL C940” from B.F. Goodrich (e.g., 0.5 to 2 wt %) and a hydrolyzed polyacrylonitrile grafted onto a starch backbone commercially available under the tradename “Waterlock A-221” from Grain Processing Co. (between 0.01 and 0.5 wt. %); organic phosphate ester surfactant RA-600 or dionyl phenol phosphate ester surfactant available under the tradename RM-510 from Rhone-Poulenc (between 100 and 1000 ppm). The term zinc as used herein shall be understood to include zinc alloy powder which comprises a very high concentration of zinc, for example, at least 99.9 percent by weight zinc. Such zinc alloy material functions electrochemically essentially as pure zinc.

With respect to anode 14 of the alkaline cell 10 of the invention, the zinc particles may be any zinc particles conventionally used in alkaline cell zinc anodes. The zinc powder mean average particle size is desirably between about 1 and 350 microns, desirably between about 1 and 250 microns, preferably between about 20 and 250 microns. The anode desirably includes zinc fines. The term zinc fines as used herein are zinc particles that have dimensions suitable to pass through a standard 200 mesh screen in a normal sieving operation, that is, when the sieve is shaken by hand. The zinc-based particles can be nominally spherical or nonspherical in shape. Nonspherical particles can be acicular in shape (i.e., having a length along a major axis at least two times a length along a minor axis) or flake-like in shape (i.e., having a thickness no more than 20 percent of the maximum linear dimension).

For example, the anode desirably includes zinc fines in an amount such that at least 10 wt. %, at least 15 wt. %, at least 30 wt. %, or between 35 and 75 wt. % of the zinc or zinc alloy particles are of 200 mesh size or smaller. For example, at least about 10 wt. %, at least 45 wt. %, or at least 80 wt. % of the zinc or zinc alloy particles can be of 325 mesh size. Preferably at least 25 wt. %, for example at least 50 wt. % of the zinc or zinc alloy particles are between about 20 and 200 mesh size (sieve square opening of between about 0.850 mm and 0.075 mm). The zinc or zinc alloy particles are preferably acicular, having a length along a major axis at least two times a length along a minor axis, or the particles can be generally flake-like, each flake generally having a thickness of no more than about 20 percent of the maximum linear dimension of the particle.

The basic electrochemical reaction taking place at the anode upon cell discharge is:
Zn→Zn⁺²+2e⁻ (Eq. 8)
Zn⁺²+2OH⁻→ZnO+H₂O (Eq. 9)

The bulk density of the zinc in the anode by way of a non-limiting example may desirably be between about 1.75 and 2.2 grams zinc per cubic centimeter of anode. The percentage by volume of the aqueous electrolyte solution in the anode may typically range between about 69.2 and 75.5 percent by volume of the anode.

The cell 10 can be balanced in the conventional manner so that the ratio of the capacity (i.e., in mA-hr) of nickel oxyhydroxide (based on 292 mA-hr per gram NiOOH) divided by the capacity (i.e., in mA-hr) of zinc (based on 820 mA-hr. per gram zinc) is about 1. However, the cell also can be balanced such that the nickel oxyhydroxide is in excess. For example, the cell can be balanced such that total the theoretical capacity of the nickel oxyhydroxide divided by the total theoretical capacity of the zinc can be between about 1 and 1.5 or as high as about 2.0. The gassing rate for a zinc/NiOOH cell of the invention can be less than that for a zinc/MnO₂ cell of the same size and type (e.g., AA). Thus, a zinc/NiOOH cell can be balanced such that the ratio of the capacity (i.e., in mA-hr) of the nickel oxyhydroxide to the capacity (i.e., in mA-hr) of zinc is about 1 and even can be balanced with zinc present in excess, for example, between about 0.8 and 1.0.

Zinc-based particles suitable for use in the Zn/NiOOH cells of the invention can be produced by any known manufacturing process for preparing fine zinc particles including gas atomization, impulse atomization, melt spinning, and air blowing. The zinc-based particles can be sorted by sieving, air classification or any other known method to produce various particle size distributions that can be mixed in suitable proportions to produce a desired particle size distribution. Alternatively, the average particle size of the zinc-based particles, as produced, can be controlled as well as the particle size distribution, to produce a desired statistical distribution of particle sizes including a significant proportion of very small zinc-based particles. Typically, the average size of the zinc-based particles can be relatively small. Zinc-based particles can have an average size of less than about 175 microns, preferably less than about 150 microns, more preferably less than about 120 microns.

One of the effects of including significant proportions of very small zinc-based particles in the distribution is an increase in the total surface area (i.e., the aggregate surface area) of the zinc-based particles in the anode. This is due to the inherent relationship between particle surface area and particle volume: namely that, for particles of similar shape, decreasing the average particle size increases the ratio of average surface area to volume of the particles. Specific surface areas of zinc-based particles can be determined from multipoint nitrogen adsorption isotherms measured by the B.E.T. method as described, for example, by P. W. Atkins (See “Physical Chemistry”, 5^{th} ed., New York: W. H. Freeman & Co., 1994, pp. 990-2). It is believed that a high measured value of specific surface area can at least partially account for the substantially improved performance demonstrated by zinc/nickel oxyhydroxide cells of the invention. Total surface area of zinc-based particles can be varied by controlling the production process or subsequent processing of the zinc-based particles.

Preferably, at least a portion of the total zinc in the anode of Zn/NiOOH cells comprises zinc fines. Zinc fines can be defined as zinc-based particles having dimensions suitable to pass through a standard 200 mesh screen (i.e., −200 mesh) in a normal sieving operation, such as when a sieve is shaken by hand. Zinc dust can be defined as zinc-based particles having dimensions suitable to pass through a standard 325 mesh screen (i.e., −325 mesh) in a normal sieving operation. The zinc-based particles can be nominally spherical or nonspherical in shape. Non-spherical zinc-based particles can be acicular in shape (i.e., having a length along a major axis at least two times a length along a minor axis) or flake-like in shape (i.e., having a thickness no more than 20 percent of the maximum linear dimension). Particle-to-particle interactions among the zinc-based particles of the anode can provide good cell performance characteristics, especially those characteristics related to discharge performance, for example, under high drain rates. This is particularly evident when the cathode includes nickel oxyhydroxide. It is believed that the particle-to-particle connectivity between large zinc-based particles and zinc fines and zinc dust is improved resulting in higher electrical conductivity at weight percentages of fine zinc particles of 50% or less. An improvement in interparticle connectivity also can produce an increase in the stability or yield point of the gelled zinc anode, thereby providing improved tolerance for mechanical shock including decreased tap load voltage instability and increased drop voltage stability for alkaline batteries having anodes including such zinc-based fine particles. See, for example, U.S. Pat. No. 6,284,410, which is incorporated by reference in its entirety.

Preparation of Zinc Particle Mixtures

The zinc-based particle mixture included in anode 14 as described herein preferably includes at least a portion of zinc fines, that is, zinc particles having dimensions sufficiently small so that they can pass through a standard 200 mesh sieve. Such a mixture of zinc-based particles can be made conveniently by mixing a batch 1 of 200 mesh (or smaller) fines with a batch 2 of larger zinc particles, for example, zinc particles between about 20 and 200 mesh. That is, the larger particles of batch 2 would pass through a 20 mesh sieve and be retained on a 200 mesh sieve. A mixture consisting of an admixture of the zinc fines of batch 1 and the larger zinc particles of batch 2 can be characterized as having a bimodal distribution when the zinc particle size distribution is plotted to reflect a frequency distribution of weight percent zinc versus particle size.

Further, the size distribution for the mixture of zinc-based particles including both zinc fines and larger zinc particles also can be characterized as having a unimodal distribution. This could occur, for example, if the zinc mixture was prepared by mixing a batch of zinc fines with a second batch of much larger zinc particles and with a third batch of zinc particles having a continuous size distribution pattern between that of the fine particles and very large particles. In such a case, the maximum in the unimodal distribution for the mixture of batches could appear between that for the fines and the large particles. Thus, it is not intended to limit the zinc mixture comprising zinc fines and larger zinc-based particles, to a bimodal or a multi-modal particle size distribution, since such a mixture could also appear to have a particle size distribution which could be characterized as unimodal. Size distributions of mixtures of zinc-based particles can be determined and represented in the manner disclosed in U.S. Pat. No. 6,284,410 and in W. F. Hess, “Evaluation and Representation of Particle Size Distributions”, Powder Handling and Processing, Vol. 14, No. 2, April/June 2002, pp. 102-108.

In the context of suitable zinc anodes for the Zn/NiOOH cell of the invention, the zinc-based particles can have a multi-modal particle size distribution, for example, one of the modes can have an average particle size of from 15 microns to 120 microns, from 30 microns to 40 microns or from 95 microns to 105 microns and another mode may typically be comprised of larger zinc particles. For zinc-based particles in a mode having an average particle size between about 30 microns and 40 microns, at least 90 volume percent of the zinc-based particles can have a particle size between about 5 microns and 100 microns, and at least 75 volume percent of the zinc-based particles can have a particle size between about 15 microns and 75 microns. For zinc-based particles in a mode having an average particle size of between about 95 microns and 105 microns, at least 90 volume percent of the zinc-based particles can have a particle size between about 15 microns and 200 microns, and at least 75 volume percent of the zinc-based particles can have a particle size between about 25 microns and 140 microns. Another mode of the zinc-based particles can have an average particle size between about 200 microns and 330 microns. For example, the average particle size of this mode can be between about 290 microns and 300 microns. For this mode, at least 90 volume percent of the particles can have a particle size between about 50 microns and 850 microns, and at least 75 volume percent of the particles can have a particle size between about 100 microns and 550 microns. For zinc-based particles having a multi-modal distribution and including zinc-based particles having different particle morphologies, more than one mode can be formed of non-spherical particles, with each mode being more or less non-spherical than the other the modes. Alternatively, one mode can be formed of nominally spherical zinc-based particles, while another mode can be formed of non-spherical zinc-based particles, for example, flake-like or acicular particles. For zinc-based particles having a multi-modal distribution of particle compositions, one mode can be formed of zinc-based particles having one composition, while another mode can be formed of zinc-based particles having another composition. For example, one mode can include zinc-based particles formed of zinc and a certain amount of one or more metals combined in an alloy that can inhibit gassing such as, for example, bismuth and indium, whereas another mode can include zinc-based particles formed of zinc and different relative amounts of one or more metals that can inhibit gassing such as, for example, bismuth and indium.

For zinc-based particles having a multi-modal distribution of particle compositions, one mode can include zinc-based particles formed of zinc, 500 parts per million (ppm) indium relative to zinc and 500 ppm bismuth relative to zinc. Alternatively, this mode can include zinc-based particles formed of zinc, 350 ppm indium relative to zinc and 150 ppm bismuth relative to zinc. For zinc-based particles having a multi-modal distribution of particle compositions, yet another mode can include zinc-based particles formed of zinc, 150 ppm indium relative to zinc and 230 ppm bismuth relative to zinc. Mixtures of zinc-based particles can include as little as 1% by weight to 10% by weight of zinc fines. Alternatively, the mixtures of zinc-based particles can include at least 10% by weight, preferably at least 50% by weight, and more preferably at least 80% by weight zinc fines. In some embodiments, 100% by weight of the zinc-based particles can be zinc fines. High levels of performance also can be achieved by the Zn/NiOOH cells of the invention, as described more fully herein, when a significant proportion of the zinc-based particles in the anode comprises zinc fines or zinc dust. In addition to zinc-based particles, the anode also includes gelling agents, surfactants, gassing inhibitors, electrolyte, and other optional performance enhancing additives.

Gelling agents can include, for example, a polyacrylic acid, a grafted starch material, a salt of a polyacrylic acid, a carboxymethylcellulose, a salt of a carboxymethylcellulose (e.g., sodium carboxymethylcellulose) or combinations thereof. Examples of a polyacrylic acid include CARBOPOL 940 and 934 (available from B.F. Goodrich) and POLYGEL 4P (available from 3V), and an example of a grafted starch material includes WATERLOCK A221 or A220 (available from Grain Processing Corporation, Muscatine, Iowa). An example of a salt of a polyacrylic acid includes ALCOSORB G1 (available from Ciba Specialties). The anode can include, for example, between, between 0.05% and 2% by weight, or between 0.1% and 1% by weight of gelling agent.

A gassing inhibitor can include a metal, such as bismuth, tin, indium, aluminum or a mixture or alloy thereof. A gassing inhibitor also can include an inorganic compound such as a metal salt, for example, an indium or bismuth salt or a mixture thereof. Alternatively, a gassing inhibitor can include an organic compound, such as a phosphate ester, an ionic surfactant or a nonionic surfactant. Examples of suitable ionic surfactants are disclosed, for example, in U.S. Pat. No. 4,777,100, incorporated by reference in its entirety.

The electrolyte can be an aqueous solution of an alkali metal hydroxide, such as potassium hydroxide, sodium hydroxide, lithium hydroxide or mixtures thereof. The electrolyte can contain between 15 wt. % and 60 wt. %, between 20 wt. % and 55 wt. %, or between 30 wt. % and 50 wt. % of the alkali metal hydroxide dissolved in water. The electrolyte can contain from 0 wt. % to 6 wt. % of a metal oxide, such as zinc oxide. The introduction of electrolyte into the cell can be assisted by application of vacuum, thereby assisting electrolyte penetration into pores of the cathode and separator. Application of vacuum during cell assembly can improve cell performance substantially.

Separator 16 can be a conventional battery separator. In some embodiments, separator 16 can be formed of two layers of non-woven, non-membrane material with one layer being disposed along a surface of the other. For example, to minimize the volume of separator 16 while providing an efficient cell, each layer of non-woven, non-membrane material can have a basic weight of 54 grams per square meter, a thickness of 5.4 mils when dry and a thickness of 10 mils when wet. The layers can be substantially devoid of fillers, such as inorganic particles. In other embodiments, separator 16 can include a layer of cellophane combined with a layer of non-woven material. The separator also can include an additional layer of non-woven material. The cellophane layer can be adjacent to cathode 12 or anode 14. The non-woven material can contain from 78 wt. % to 82 wt. % polyvinyl alcohol and from 18 wt. % to 22 wt. % rayon with a trace amount of a surfactant, such as non-woven material available from PDM under the trade name PA25. The separator also can include a microporous membrane optionally combined with or laminated to one or more layers of a non-woven material.

Housing 18 can be a conventional battery housing fabricated from metal, such as, for example, nickel-plated cold-rolled steel, commonly used for primary alkaline batteries. The housing can include an inner conductive metal wall and an outer electrically non-conductive layer such as a heat shrinkable plastic. A layer of an electrically conductive material can be disposed between the inner wall of housing 18 and cathode 12. The conductive layer can be disposed on the inner surface of housing 18, along the circumference of cathode 12 or both. The conductive layer can be formed, for example, of a carbonaceous material (e.g., colloidal graphite), such as LB1000 (Timcal), Eccocoat 257 (W.R. Grace & Co.), Electrodag 109 (Acheson Colloids Company), Electrodag EB-009 (Acheson), Electrodag 112 (Acheson) and EB0005 (Acheson). However, a conductive layer including an oxidation resistant graphite is preferred. Suitable methods for applying the conductive layer are disclosed in, for example, Canadian Patent No. 1,263,697, incorporated by reference in its entirety.

An anode current collector 20 passes through seal 22 extending into anode 14 and can be made from a suitable metal, such as brass or brass plated steel. The upper end of current collector 20 electrically contacts negative metal top cap 24. Seal 22 can be made, for example, of nylon.

The following Examples relate to alkaline primary batteries including a cathode comprising a nickel oxyhydroxide and an oxidation-resistant graphite, and an anode comprising zinc fines. For each example, the total energy output of a fresh cell was determined at a specific constant power drain rate and the energy output of an identical fresh cell was determined at a specific intermittent power drain rate. The Performance Index was calculated as follows.

### Cell Performance Index

The relative performance of an electrochemical cell can be evaluated by different test methods depending on the intended application, for example, primarily for high power or primarily for low power applications. Thus, the performance of a cell can be evaluated by discharging the cell continuously at preset low, medium or high drain rates. The performance of a cell also can be evaluated by subjecting the cell to intermittent or pulsed discharge at constant current or constant power at various drain rates. For example, in a typical intermittent discharge test, a cell can be discharged for a specific period of time (e.g., several seconds to minutes) at a specified high drain rate, then immediately discharged for a specific period of time at a lower drain rate, next allowed to rest, and the discharge cycle repeated until a specified cut off voltage is reached. Such an intermittent or pulsed discharge test can be used to estimate service life of a cell under intermittent usage in a device. The continuous and intermittent test results can be used in the aggregate to characterize overall cell performance and also to determine the effect of, for example, modifying anode or cathode composition, electrolyte composition, cell balance or introducing additives on cell performance.

When a cell is discharged continuously at constant current or constant power, polarization of an electrode can take place, especially at high drain rates. The deleterious effect of polarization on cell performance has already been discussed herein. Polarization can arise from various sources, for example, any process that limits mobility of ions within the electrode, active material or electrolyte. This can result in reduced cell service life. In a typical intermittent discharge test, during pauses between the periods of high drain, ions can have sufficient time to diffuse and replenish the ions near the electrode surface, thereby reducing the extent of polarization. Thus, it will be appreciated that the total energy output (i.e., Watt-hrs) of a cell tested intermittently at a high drain rate, for example, 1 watt (i.e., discharged intermittently at 1 Watt) will generally be greater than that for the same cell discharged at a constant drain rate of 1 watt to the same cut-off voltage.

A “Performance Index” can be defined which can be used to characterize the overall cell performance based on the aggregate cell performance in both continuous and intermittent discharge test regimes. Thus, a higher value for the performance index is indicative of better overall cell performance. The performance index, designated as “PI”, can be defined as follows:
PI=[X_{cont}/Xᵢₙₜ+Xᵢₙₜ/D]/2 (Eq. 10)

Where:
PI=performance index
X_{cont}=capacity (Watt-hrs) for continuous discharge at a specified constant power drain rate
Xᵢₙₜ=capacity (Watt-hrs) for intermittent discharge at a specified drain rate (i.e., same as for X_{cont}) and duty cycle
D=design capacity of the cell (i.e., theoretical capacity, in watt-hrs, based on the limiting cell capacity)

As noted above, the value of Xᵢₙₜ is typically greater than that for X_{cont} and less than that for D. As the value for X_{cont} approaches that for Xᵢₙₜ, it is believed that the influence of electrode polarization on cell performance is decreased. As the value for Xᵢₙₜ approaches the theoretical capacity, D, it is believed that cell efficiency (i.e., utilization of anode and cathode active materials) increases. Thus, as will be appreciated from Eq. 10, the maximum value for performance index, PI, can be obtained (viz., for a combination of continuous and intermittent discharge tests at comparable drain rates), when both the value of X_{cont} approaches that of Xᵢₙₜ and the value of Xᵢₙₜ approaches the value of D.

The following test protocol can be applied to the evaluation of the performance index for zinc/nickel oxyhydroxide as well as for zinc/manganese oxide cells. Typically, continuous and intermittent tests are conducted at high power drain rates suitable for a particular cell chemistry and size. It is believed that the extent of polarization should be greatest at high drain rates. The specific continuous and intermittent discharge tests can be varied, but a preferred procedure for evaluating an alkaline cell is as follows:

The value for X_{cont} (in watt-hrs) can be determined by discharging a fresh cell at a constant power drain rate of 1 watt until a specified cut-off voltage, for example, 0.9 Volts is reached. The value for Xᵢₙₜ (in watt-hrs) can be determined by discharging a fresh cell at a suitable intermittent power drain rate, for example, at a drain rate of 1 watt for a period of 3 seconds, followed immediately by a drain rate of 0.1 watt for 7 seconds, and then the cycle repeated until a specified cut-off voltage, for example, 0.9 Volts is reached. Along with the known design capacity, D, the values for X_{cont} and Xᵢₙₜ can be used to calculate the performance index according to Eq. 10.

A “fresh” cell for the purpose of evaluating performance index, unless otherwise specified, is defined herein as a cell evaluated within the time period beginning with the fourth day and ending with the fifteenth day after cell manufacture. It is believed that various internal chemical processes of an alkaline cell achieve a quasi-steady state within about three days after manufacture and that it is desirable to wait for at least this period of time before beginning performance testing. Further, it shall be understood that the term “performance index” as used herein and in the claims, unless otherwise specified, is derived from results of cell performance tests performed within the time period beginning on the fourth day and ending on the fifteenth day after cell manufacture. Unless otherwise specified, it shall be understood that all cells were stored at ambient room temperature during the time period before testing.

### EXAMPLES

The following specific examples demonstrate the performance of cylindrical AA size (13.7 mm×47.3 mm) alkaline test cells of the invention compared with the performance of AA size cells with conventional zinc-based anodes and nickel oxyhydroxide cathodes containing natural graphite. Test cells of the invention include an anode comprising a mixture of zinc fines and conventional zinc-based powder and a cathode comprising nickel oxyhydroxide and an oxidation-resistant graphite.

To evaluate relative performance, fresh test cells of each Example and Comparative Example were discharged continuously and intermittently at the indicated constant power drain rates for the indicated duty cycles. The total energy output (in Watt-hrs) was measured and the corresponding performance index values calculated. Specifically, for each Example and Comparative Example, fresh test cells were discharged continuously at a 1 Watt drain rate until the cell voltage decreased to 0.9 Volt and the total energy output was recorded (Table 4). Identical fresh test cells were discharged intermittently at a 1 Watt drain rate for 3 seconds followed immediately by discharge at a 0.1 Watt drain rate for 7 seconds and then this cycle repeated until the cell voltage decreased to 0.9 Volt and the total energy output recorded. Performance index values were calculated as described hereinabove and are summarized in Table 4.

Three slightly different cathode formulations were used to prepare mixtures for the fabrication of cathodes for the test cells of the Examples and Comparative Examples. These cathode formulations are designated as “formulation A”, “formulation B”, and “formulation C” and are given in Table 1.

TABLE 1
Cathode Formulations

| | Formulation | Formulation | Formulation |
|---|---|---|---|
| Component | A (wt %) | B (wt %) | C (wt %) |
| NiOOH¹ | 87 | 85 | 85 |
| Natural graphite² | 6 | 8 | 0 |
| Oxidation-resistant | 0 | 0 | 8 |
| graphite³ | | | |
| Polyethylene | 1 | 1 | 1 |
| binder⁴ | | | |
| Electrolyte | 6 | 6 | 6 |
| solution⁵ | | | |
| Notes: | | | |
| ¹NiOOH powder is primarily beta-nickel (+3) oxyhydroxide having a mean average particle size of about 19 microns. The NiOOH particles have a surface coating of cobalt oxyhydroxide in the amount of about 4 percent by weight of the pure NiOOH. | | | |
| # The total amount of active NiOOH was about 85/1.04 = 81.7 percent by weight of the cathode. Cobalt oxyhydroxide-coated beta-nickel oxyhydroxide is commercially available from Kansai Catalyst Co., Ltd. (Osaka, Japan). | | | |

²Graphite MP-0507 is a natural graphite having an average particle size of about 7 microns, a BET surface area of about 10 m²/g, a crystallite size, Lc > 200 nm, and is available from Nacional de Grafite (Itapecerica, MG Brazil).
³Graphite Timrex ® SFG15 is a synthetic oxidation-resistant graphite having an average particle size of about 9 microns, a BET surface area of about 9.5 m²/g, a crystallite size, Lc > 100 nm, and is available from Timcal-America (Westlake, OH).
⁴Polyethylene binder under the trade designation “Coathylene” from Hoechst Celanese.
⁵The aqueous electrolyte solution contains 38% by weight of dissolved KOH and about 2% by weight of dissolved zinc oxide.

The nickel oxyhydroxide was a cobalt oxyhydroxide coated beta-nickel oxyhydroxide. A typical cobalt oxyhydroxide coated beta-nickel oxyhydroxide had the following nominal composition: NiOOH 90.2 wt %; COOOH 6.6 wt %, NaOH 1.5 wt %, moisture 1.6 wt %.

Three different anode formulations were used to prepare anode slurries for the test cells of the Examples and the Comparative Examples. The anode formulations, of which one contained only relatively large zinc-based particles (−20/+200 mesh), one contained 50 wt. % zinc fines (−325 mesh), and another contained 70 wt. % zinc fines (−325 mesh) are designated as “formulation D”, “formulation E”, and “formulation F”, respectively, and are summarized in Table 2. In anodes with formulation E, a mixture of zinc fines and larger zinc-based particles was prepared by mixing a batch 1 of the zinc fines with a batch 2 of the larger zinc-based particles in a weight ratio of batch 1 to batch 2 of about 1 to 1. The mean average particle size of the resulting mixture was about 125 microns. In anodes having formulation F, a mixture of zinc fines and larger zinc-based particles was prepared by mixing a batch 1 of the zinc fines with a batch 2 of the larger zinc-based particles in a weight ratio of about 7 to 3. The mean average particle size of the resulting mixture was about 50 microns.

TABLE 2
Anode Formulations

| | Formulation | Formulation | Formulation |
|---|---|---|---|
| Component | D (wt %) | E (wt %) | F (wt %) |
| Large Particle Zinc¹ | 64.00 | 32.00 | 19.20 |
| (−20/+200 mesh) | | | |
| Zinc fines² (−325 mesh) | 0 | 32.00 | 44.80 |
| Gelling agent 1³ | 0.522 | 0.522 | 0.522 |
| Gelling agent 2⁴ | 0.036 | 0.036 | 0.036 |
| Surfactant⁵ | 0.107 | 0.107 | 0.107 |
| Gassing inhibitor⁶ | 0.029 | 0.029 | 0.029 |
| Electrolyte⁷ | 35.306 | 35.306 | 35.306 |

^{Notes:}
¹Zinc-based particles having a mean average particle size of about 370 microns and were alloyed and plated with indium to give a total indium content of about 350 ppm.
²Zinc-based particles having a mean average particle size of about 35 microns and were alloyed and plated with indium to give a total indium content of about 700 ppm.
³A polyacrylic acid-based gelling agent available under the tradename Carbopol 940 from B.F. Goodrich Co.
⁴A grafted starch-based gelling agent available under the tradename Waterlock A221 from Grain Processing Corp.
⁵An organic phosphate ester-based surfactant available in the form of a 3 wt % solution under the tradename RM 510 from Rhône Poulenc.
⁶Indium acetate added as an inorganic gassing inhibitor.
⁷The electrolyte solution contained 35.4% by weight of dissolved KOH and about 2% by weight of dissolved zinc oxide.

The specific combinations of anode formulation and cathode formulation used to prepare the anodes and cathodes for the test cells of the Examples and Comparative Examples are summarized in Table 3.

TABLE 3
Compositions of Test Cells

| | Cathode | Anode | Can Coating |
|---|---|---|---|
| Test Cells | Formulation | Formulation | Type |
| Comparative Ex. 1 | A | D | Standard |
| Comparative Ex. 2 | B | D | Standard |
| Example 1 | B | E | Standard |
| Example 2 | C | E | Standard |
| Example 3 | C | F | Standard |
| Example 4 | C | F | Oxidation- |
| | | | resistant |

Comparative Example 1 (Anode formulation D, 0 wt % zinc fines)
(Cathode formulation A, 6 wt % natural graphite, 0 wt % oxidation resistant graphite)

Test cells of AA size were fabricated having an anode of formulation D and a cathode of formulation A. Thus, the anode did not contain any zinc fines and the cathode contained 6 wt. % natural graphite. The capacities of the anode and cathode were balanced such that the theoretical capacity of the NiOOH (based on 292 mA-hr per gram NiOOH) divided by the theoretical capacity of the zinc (based on 820 mA-hr per gram zinc) was about 0.76. The cathode contained about 8 grams of NiOOH (i.e., pure basis).

Fresh test cells were discharged continuously at 1 Watt until cell voltage decreased to 0.9 Volt. Total energy output was 1.27 Watt-hrs corresponding to a service life of 1.27 hours (Table 5). Other fresh test cells were discharged intermittently at 1 Watt for 3 seconds followed immediately by 0.1 Watt for 7 seconds and the cycle repeated until cell voltage decreased to 0.9 Volt. Total energy output was 2.21 Watt-hrs corresponding to a service life of 5.95 hours (Table 5). The performance index for fresh test cells of Comparative Example 1 was 0.62. Other test cells were discharged intermittently at 1 Watt for 10 seconds immediately followed by a 1 minute rest period, this cycle repeated for 1 hour, then followed by 6 hours of rest, and the entire cycle repeated until cell voltage decreased to a pre-determined voltage and the service life reported (Table 5).

The same discharge tests were repeated using test cells stored for 1 week at 60° C. before discharge at room temperature. The total energy output was 0.635 Watt-hrs for fresh cells discharged continuously at 1 Watt and 0.958 Watt-hrs for cells discharged intermittently at 1 Watt. This corresponds to service life values of 0.62 hours for continuous and 2.58 hours for intermittent discharge at 1 Watt. The performance index for stored test cells of Comparative Example 1 was 0.47. Other stored test cells were discharged intermittently at 1 Watt for 10 seconds immediately followed by a 1 minute rest period, this cycle repeated for 1 hour, then followed by 6 hours of rest, and the entire cycle repeated until cell voltage decreased to a pre-determined voltage and the service life reported (Table 5).

### Comparative Example 2

### (Anode Formulation D, 0 wt % Zinc Fines) (Cathode Formulation B, 8 wt % Natural Graphite, 0 wt % Oxidation Resistant Graphite)

Test cells of AA size were fabricated having an anode of formulation D and a cathode of formulation B. The anode did not contain any zinc fines and the cathode contained 8 wt. % natural graphite. The capacities of the anode and cathode were balanced such that the theoretical capacity of the NiOOH (based on 292 mA-hr per gram NiOOH) divided by the theoretical capacity of the zinc (based on 820 mA-hr per gram zinc) was about 0.75. The cathode contained about 8 grams NiOOH (i.e., on a pure basis).

Fresh test cells were discharged continuously at 1 Watt until cell voltage decreased to 0.9 Volt. Total energy output was 1.13 Watt-hrs. Other fresh test cells were discharged intermittently at 1 Watt for 3 seconds followed immediately by 0.1 Watt for 7 seconds and the cycle repeated until cell voltage decreased to 0.9 Volt. Total energy output was 2.28 Watt-hrs. The performance index for the test cells of Comparative Example 2 was 0.61.

The same discharge tests were repeated using test cells stored for 1 week at 60° C. before discharge at room temperature. The total energy output for cells discharged continuously at 1 Watt was 0.76 Watt-hrs and for cells discharged intermittently at 1 Watt was 1.15 Watt-hrs. The performance index for the stored test cells of Comparative Example 2 was 0.51.

### Example 1

### (Anode Formulation E, 32 wt % −325 Mesh Zinc Fines) (Cathode Formulation B, 8 wt % Natural Graphite, 0 wt % Oxidation Resistant Graphite)

Test cells of AA size were fabricated having an anode of formulation E and a cathode of formulation B. The amounts of NiOOH and natural graphite in the cathode, total zinc in the anode, and the cell balance were the same as for Comparative Example 2. However, 50% of the total zinc in the anode was in the form of zinc fines (i.e., −325 mesh).

Fresh test cells were discharged continuously at 1 Watt until cell voltage decreased to 0.9 Volt. Total energy output was 1.31 Watt-hrs corresponding to a service life of 1.31 hours. Other fresh test cells were discharged intermittently at 1 Watt until cell voltage decreased to 0.9 Volt. Total energy output was 2.34 Watt-hrs corresponding to a service life of 6.28 hours. The performance index for fresh test cells of Example 1 was 0.65. Other test cells were discharged intermittently at 1 Watt for 10 seconds immediately followed by a 1 minute rest period, this cycle repeated for 1 hour, followed by 6 hours of rest, and the entire cycle repeated until cell voltage decreased to a pre-determined voltage and the service life reported (Table 5).

The same discharge tests were repeated using test cells stored 1 week at 60° C. before discharge. Total energy output was 1.18 Watt-hrs for cells discharged continuously at 1 Watt and 1.81 Watt-hrs for cells discharged intermittently at 1 Watt. Corresponding service life values were 1.18 hours for continuous and 4.85 hours for intermittent discharge at 1 Watt. The performance index value for stored cells of Example 1 was 0.61. Other stored cells were discharged intermittently at 1 Watt for 10 seconds immediately followed by a 1 minute rest period, this cycle repeated for 1 hour, then followed by 6 hours of rest, and the entire cycle repeated until cell voltage decreased to a pre-determined voltage and service life reported (Table 5).

### Example 2

### (Anode Formulation E, 32 wt % −325 Mesh Zinc Fines) (Cathode Formulation C, 8 wt % Oxidation Resistant Graphite)

Test cells of AA size having an anode of formulation E and a cathode of formulation C were fabricated. The amounts of NiOOH and graphite in the cathode and total zinc in the anode were the same as used in the test cells of Example 1. An oxidation-resistant synthetic graphite was substituted for the natural graphite in the cathode and 50% of the total zinc in the anode was in the form of zinc fines.

Fresh test cells were discharged continuously at 1 Watt until cell voltage decreased to 0.9 Volt. Total energy output was 1.53 Watt-hrs. Other fresh test cells were discharged intermittently at 1 Watt until cell voltage decreased to 0.9 Volt. Total energy output was 2.24 Watt-hrs. The performance index for fresh test cells of Example 2 was 0.71. The same tests were repeated using test cells stored for 1 week at 60° C. before discharge at room temperature. Total energy output was 1.30 Watt-hrs for cells discharged continuously at 1 Watt and 1.94 Watt-hrs for cells discharged intermittently at 1 Watt. The performance index for stored test cells of Example 2 was 0.66.

### Example 3

### (Anode Formulation F, 44.8 wt % −325 Mesh Zinc Fines) (Cathode Formulation C, 8 wt % Oxidation Resistant Graphite)

Test cells of AA size having an anode of formulation F and a cathode of formulation C were fabricated. The amounts of NiOOH and graphite in the cathode and total zinc in the anode were the same as used in the test cells of Example 2. In addition to the oxidation-resistant graphite in the cathode, 70% of the total zinc in the anode was in the form of zinc fines (i.e., −325 mesh).

Fresh test cells were discharged continuously at 1 Watt until cell voltage decreased to 0.9 Volt. Total energy output was 1.76 Watt-hrs. Other fresh test cells were discharged intermittently at 1 Watt until cell voltage decreased to 0.9 Volt. Total energy output was 2.23 Watt-hrs. The performance index for fresh test cells of Example 3 was 0.76. The same tests were repeated using test cells stored for 1 week at 60° C. before discharge at room temperature. The total energy output was 1.40 Watt-hrs for stored cells discharged continuously at 1 Watt and 1.91 Watt-hrs for cells discharged intermittently at 1 Watt. The performance index for stored test cells of Example 3 was 0.68.

### Example 4

### (Anode Formulation F, 44.8 wt % of −325 Mesh Zinc Fines) (Cathode Formulation C, 8 wt % Oxidation Resistant Graphite) (Inside Surface of Cell Casing Coated with Coating Containing Oxidation Resistant Graphite)

Test cells of AA size having an anode of formulation F and a cathode of formulation C were fabricated. The amounts of NiOOH and graphite in the cathode and total zinc in the anode were the same as used in the test cells of Example 2. However, in addition to oxidation-resistant synthetic graphite in the cathode, the can coating also contained oxidation-resistant synthetic graphite, and 70% of the total zinc in the anode was in the form of zinc fines (i.e., −325 mesh).

Fresh test cells were discharged continuously at 1 Watt until cell voltage decreased to 0.9 Volt. Total energy output was 1.82 Watt-hrs. Other fresh test cells were discharged intermittently at 1 Watt until cell voltage decreased to 0.9 Volt. Total energy output was 2.38 Watt-hrs. The performance index for fresh test cells of Example 4 was 0.78. The same tests were repeated using test cells stored for 1 week at 60° C. before discharge at room temperature. Total energy output was 1.66 Watt-hrs for cells discharged continuously at 1 Watt and 2.06 Watt-hrs for cells discharged intermittently at 1 Watt. The performance index for stored test cells of Example 4 was 0.74.

TABLE 4
Performance Index

| | Capacity to 0.9 V | | | |
|---|---|---|---|---|
| | (W-hrs) | | | |
| | | Cont. | Intermit. | Performance |
| | Theoret. | 1 Watt | 1 Watt | Index |
| Zn/NiOOH Cells | | | | |
| tested FRESH | | | | |
| Comparative Ex. 1 | 3.30 | 1.27 | 2.21 | 0.62 |
| 0% zinc fines in | | | | |
| anode and 0% | | | | |
| oxidation resistant | | | | |
| graphite and 6 wt % | | | | |
| natural graphite in | | | | |
| cathode | | | | |
| Comparative Ex. 2 | 3.18 | 1.13 | 2.28 | 0.61 |
| 0% zinc fines in | | | | |
| anode and 0% | | | | |
| oxidation resistant | | | | |
| graphite and 8 wt % | | | | |
| natural graphite in | | | | |
| cathode | | | | |
| Example 1 | 3.18 | 1.31 | 2.34 | 0.65 |
| 32 wt % Zinc | | | | |
| fines in anode and | | | | |
| 0% oxidation | | | | |
| resistant graphite | | | | |
| and 8 wt % natural | | | | |
| graphite in cathode | | | | |
| Example 2 | 3.03 | 1.53 | 2.24 | 0.71 |
| 32 wt % Zinc | | | | |
| fines in anode and | | | | |
| 8 wt % oxidation | | | | |
| resistant graphite | | | | |
| in cathode | | | | |
| Example 3 | 3.03 | 1.76 | 2.23 | 0.76 |
| 44.8 wt % zinc | | | | |
| fines in anode and | | | | |
| 8 wt % oxidation | | | | |
| resistant graphite | | | | |
| in cathode | | | | |
| Example 4 | 3.03 | 1.82 | 2.38 | 0.78 |
| 44.8 wt % Zinc | | | | |
| fines in anode and | | | | |
| 8 wt % oxidation | | | | |
| resistant graphite | | | | |
| in cathode. Cell | | | | |
| casing coated | | | | |
| inside with | | | | |
| oxidation resistant | | | | |
| graphite coating | | | | |
| Zn/NiOOH Cells | | | | |
| tested AFTER | | | | |
| STORAGE for 1 week | | | | |
| at 60° C. | | | | |
| Comparative Ex. 1 | 3.30 | 0.625 | 0.958 | 0.47 |
| Comparative Ex. 2 | 3.18 | 0.76 | 1.15 | 0.51 |
| Example 1 | 3.18 | 1.18 | 1.81 | 0.61 |
| Example 2 | 3.03 | 1.30 | 1.94 | 0.66 |
| Example 3 | 3.03 | 1.40 | 1.91 | 0.68 |
| Example 4 | 3.03 | 1.66 | 2.06 | 0.74 |

The effect of the three different anode formulations (Table 2) having different amounts of zinc fines and the three different cathode formulations (Table 1) having different graphite types and levels on discharge performance was evaluated for freshly prepared Zn/NiOOH AA test cells, and for cells stored for one week at 60° C. before discharge. Fresh test cells of Comparative Example 2 having 8 wt. % natural graphite and no zinc fines showed little or no improvement in capacity when discharged either continuously or intermittently at 1 Watt compared to test cells of Comparative Example 1 having 6 wt. % natural graphite and no zinc fines. However, the test cells of Comparative Example 2 stored for 1 week at 60° C. before discharge had continuous and intermittent discharge capacities nearly 20% greater than the test cells of Comparative Example 1. Thus, increasing the graphite level in the cathode, e.g., from 6 to 8 wt. %, can improve post-storage performance of Zn/NiOOH cells.

Addition of 50 wt. % zinc fines to test cells of Example 1 including 8 wt. % natural graphite increased both continuous and intermittent discharge capacities of stored cells of Example 1 by 55-57% compared to cells of Comparative Example 2 without zinc fines. The performance index for the stored cells of Example 1 was much greater than that for the stored cells of Comparative Examples 1 and 2. The corresponding improvement in continuous and intermittent discharge capacities for fresh cells of Example 1 was not nearly as great. Further, the performance index (Table 4) for fresh cells of Example 1 was greater than that for fresh cells of Comparative Examples 1 and 2. The combined effect of adding 50 wt. % zinc fines to the anode and increasing graphite level to 8 wt. % in the cathode was greatest for cells stored one week at 60° C. before discharge. Both continuous and intermittent discharge capacities were increased by nearly 90% compared to stored cells of Comparative Example 1 (Table 4).

Test cells of Example 1 and Comparative Example 1 also were evaluated further with another intermittent discharge test having longer duration 1 watt pulses and longer pauses between pulses as well as periods of time between discharge cycles. Specifically, cells were discharged at 1 Watt for 10 seconds, followed by a 1 minute pause, then the pulse/pause cycle repeated continuously for 1 hour, followed by a 6 hour rest period, and then the entire test repeated until cell voltage reached a pre-determined voltage. The service life of the fresh cells of Example 1 was nearly 35-40% greater than that of cells of Comparative Example 1 (Table 5). This percentage improvement in service life was much greater than that for fresh cells of Example 1 discharged either continuously at 1 Watt or intermittently at 1 Watt (i.e., 1 Watt for 3 seconds, 0.1 Watt for 7 seconds). Service life of stored cells of Example 1 was 60-70% greater than that of cells of Comparative Example 1. Further, the percentage improvement in service life for stored cells of Example 1 was nearly 90% for cells discharged continuously or intermittently at 1 Watt using the intermittent test with the shorter duration pulse/pause cycle (Table 5).

Replacement of the natural graphite in the test cells of Example 2 with the same amount (i.e., 8 wt. %) of an oxidation-resistant synthetic graphite, increased both continuous and intermittent discharge capacities of stored cells of Example 2 by nearly 10% compared to those of Example 1. The continuous discharge capacity of fresh cells of Example 2 increased by about 15%, whereas the corresponding intermittent discharge capacity decreased slightly. However, the performance index value increased for both fresh and stored cells of Example 2 compared to the corresponding cells of Example 1.

Increasing the percentage of zinc fines in the test cells of Example 3 from 50 wt. % to 70 wt. % while keeping the oxidation-resistant graphite level constant at 8 wt. % further increased the continuous discharge capacity of stored cells of Example 3 by 10% whereas the corresponding intermittent capacity was nearly the same as that of cells of Example 2. The continuous capacity of fresh cells of Example 3 increased by 15%, whereas the corresponding intermittent capacity was nearly the same as that of the cells of Example 2. The performance index (Table 4) increased for both fresh and stored cells of Example 3 compared to that of Example 2.

TABLE 5
Test Cell Performance

| | | | |
|---|---|---|---|
| | Comp. Ex. 1 | Example 1 | |
| Test Cells | Service Hrs | Service Hrs | % Gain |

Cells Tested FRESH

| | | | |
|---|---|---|---|
| 1.0 Watt Continuous to 1.0 V | 1.2 | 1.31 | 9.2 |
| 1.0 Watt Continuous to 0.9 V | 1.2 | 1.31 | 9.2 |
| 1.0/0.1 Watt 3 s/7 s to 1.0 V | 5.93 | 6.24 | 5.2 |
| 1.0/0.1 Watt 3 s/7 s to 0.9 V | 5.95 | 6.28 | 5.5 |
| 1.0 Watt 10 s/m−1 Hr/6 hr to 1.0 V | 1.75 | 2.45 | 40.0 |
| 1.0 Watt 10 s/m−1 hr/6 hr to 0.9 V | 1.83 | 2.48 | 35.5 |

Cells Tested AFTER 1 Week STORAGE at 60° C.

| | | | |
|---|---|---|---|
| 1.0 Watt Continuous to 1.0 V | 0.62 | 1.16 | 87.1 |
| 1.0 Watt Continuous to 0.9 V | 0.62 | 1.18 | 90.3 |
| 1.0/0.1 Watt 3 s/7 s to 1.0 V | 2.57 | 4.82 | 87.5 |
| 1.0/0.1 Watt 3 s/7 s to 0.9 V | 2.58 | 4.85 | 88.0 |
| 1.0 Watt 10 s/m−1 Hr/6 hr to 1.0 V | 1.2 | 2.02 | 68.3 |
| 1.0 Watt 10 s/m−1 hr/6 hr to 0.9 V | 1.28 | 2.07 | 61.7 |

Replacement of the conductive carbon in the coating applied to the inside surface of the cell housings with an oxidation-resistant synthetic graphite increased both continuous and intermittent discharge capacities of stored cells of Example 4 by 10-20% compared to the stored cells of Example 3 having a standard can coating and 70 wt. % zinc fines. However, the corresponding improvements in continuous and intermittent discharge capacities for fresh cells of Example 4 were only 3-7%. Significantly, the capacities retained by stored cells of Example 4 discharged continuously or intermittently were 80-90%. This should be compared to capacity retention values of 40-50% for the cells of Comparative Example 1. In fact, the performance index (Table 4) increased for both fresh and stored cells of Example 4 compared to those of Example 3. Performance index values for both fresh and stored cells of Example 4 were higher than those for the test cells of any other Examples.

The Examples disclosed herein clearly demonstrate that both the continuous and the intermittent discharge performance of the Zn/NiOOH alkaline cells of the invention discharged after storage were improved substantially when zinc fines were added to the anode. Increasing the relative percentage of zinc fines, for example, from 50 to 70% of the total zinc in the anode increased the capacity of both fresh and stored cells discharged continuously, but not intermittently at 1 Watt. In addition to the large improvement in performance afforded by adding zinc fines to the zinc in the anode, the continuous and intermittent discharge capacities of both fresh and stored Zn/NiOOH cells of the invention were increased even further by substituting an oxidation-resistant graphite for the natural graphite in the cathode and the can coating. The combination of oxidation-resistant graphite in the cathode and zinc fines in the anode of the Zn/NiOOH cells of the invention is theorized to be particularly effective at delaying onset of polarization of the zinc anode when the Zn/NiOOH cell is discharged at high drain rates either continuously or intermittently, especially after storage for prolonged periods of time at a high temperature before discharge. (Additional benefit may also be obtained by coating the inside surface of the cell housing with the oxidation resistant graphite.) The delay in onset of polarization of the zinc anode, which in turn results in additional improved cell performance, is a direct result of use in the present invention of the combination of zinc fines in the anode together with the oxidation resistant graphite in the cathode. More specifically, the combination of use of zinc fines in the anode together with the oxidation resistant graphite in the cathode (and optionally also using the oxidation resistant graphite as a coating for the cell housing inside surface) increases both continuous and intermittent discharge capacities of both fresh cells and cells which are stored for periods for time, for example, even up to one year and longer.

Although the invention was described with respect to various specific embodiments, it will be appreciated that other embodiments are possible and within the concept of the invention. Thus, the invention is not intended to be limited to the specific embodiments herein and is reflected by the scope of the claims.

What is claimed is:

1. A primary alkaline cell comprising a negative and a positive terminal, and an outer housing having a closed end and opposing open end, said cell further comprising an anode comprising zinc or zinc alloy particles and a cathode comprising nickel oxyhydroxide particles within said housing, a separator between said anode and cathode, an alkaline electrolyte solution contacting said anode and cathode, and an end cap assembly sealing the open end of said housing thereby forming a boundary surface around the cell interior; wherein at least 1 percent by weight of the total zinc in the anode comprises zinc fines of dimensions suitable to pass through a standard 200 mesh sieve having square openings of 0.075 mm, wherein said cathode further comprises conductive carbon particles, said carbon particles comprising a synthetic graphite with a substantially high crystalline structure having a Raman defect ratio less than about 0.250, thereby enabling said graphite with oxidation resistant properties.

2. The alkaline cell of claim 1 wherein said oxidation resistant graphite has a Raman defect ratio of between about 0.050 and 0.250.

3. The alkaline cell of claim 1 wherein said oxidation resistant graphite has a Raman defect ratio of between about 0.050 and 0.15.

4. The alkaline cell of claim 1 wherein said oxidation resistant graphite comprises between about 10 and 100 wt % of said conductive carbon particles.

5. The alkaline cell of claim 1 wherein said nickel oxyhydroxide and said oxidation resistant graphite are in particulate form, wherein said nickel oxyhydroxide has a an average particle size between about 2 and 50 micron and said oxidation resistant graphite has an average particle size between about 1 and 50 micron.

6. The alkaline cell of claim 1 wherein said nickel oxyhydroxide and said oxidation resistant graphite are in particulate form, wherein said nickel oxyhydroxide has a an average particle size between about 5 and 30 micron and said oxidation resistant graphite has an average particle size between about 5 and 30 micron.

7. The alkaline cell of claim 1 wherein said nickel oxyhydroxide and said oxidation resistant graphite are in particulate form, wherein said nickel oxyhydroxide has a an average particle size between about 5 and 20 micron and said oxidation resistant graphite has an average particle size between about 2 and 10 micron.

8. The alkaline cell of claim 1 wherein between 24 and 75 wt % of the zinc or zinc alloy particles are of −200 mesh size or smaller.

9. The alkaline cell of claim 1 wherein at least 1 percent by weight of the total zinc in the anode comprises zinc fines of dimensions suitable to pass through a standard 325 mesh sieve having square openings of 0.045 mm.

10. The alkaline cell of claim 1 wherein at least a portion of the surface of said nickel oxyhydroxide particles is coated with cobalt oxyhydroxide.

11. The alkaline cell of claim 1 wherein said oxidation resistant graphite has a total ash content of less than 0.1 percent by weight.

12. The alkaline cell of claim 1 wherein said oxidation resistant graphite has a B.E.T. specific surface area of less than 15 m²/g.

13. The alkaline cell of claim 11, wherein the oxidation resistant graphite has a high degree of crystallinity, characterized by having a value for crystallite size, in the “c” crystal axis direction, L_{c}, of greater than 150 nanometers and a d₀₀₂ lattice constant of less than 0.3356 nanometers.

14. The alkaline cell of claims 1 wherein said nickel oxyhydroxide further comprises a bulk dopant selected from the group consisting of aluminum, manganese, cobalt, zinc, gallium, indium, and mixture thereof.

15. The alkaline cell of claim 1 wherein said nickel oxyhydroxide is selected from the group consisting of beta-nickel oxyhydroxide, gamma-nickel oxyhydroxide, and mixtures thereof.

16. The alkaline cell of claim 1 wherein at least a portion of the surfaces of said nickel oxyhydroxide particles is coated with cobalt oxyhydroxide.

17. The alkaline cell of claim 1 wherein said cathode comprises between about 80 and 95 percent by weight nickel oxyhydroxide.

18. The alkaline cell of claim 1 wherein said electrolyte solution comprises an aqueous solution of an alkali metal hydroxide salt selected from the group consisting of potassium hydroxide, sodium hydroxide, lithium hydroxide, and mixtures thereof.

19. The alkaline cell of claim 1 wherein a side of said outer housing faces said cathode and said side has a coating thereon comprising said oxidation resistant graphite with a crystalline structure having a Raman defect ratio of less than about 0.250.

20. The alkaline cell of claim 1 wherein said cell is an AA size cell having an actual energy output between about 1.31 and 1.78 Watt-hours when drained at a constant power drain of 1 Watt to a cut off voltage of 0.9 Volts, and said cell having a performance index of between about 0.65 and 0.78 wherein the performance index is calculated using the formula:
Performance Index=[X_{cont}/Xᵢₙₜ+Xᵢₙₜ/D]/2
wherein:
X_{cont} (Watt-hrs) is determined by subjecting said cell to a constant power drain of 1 Watt to a cut off voltage of 0.9 volts;
Xᵢₙₜ (Watt-hrs) is determined by subjecting said cell to a first power drain wherein the cell is subjected to a drain of 1 Watt for a period of 3 seconds, followed immediately by subjecting the same cell to a second power drain at 0.1 Watt for 7 seconds, said first drain followed by said second drain comprising a single cycle, said single cycle being repeated over and over continuously to a cutoff voltage of 0.9 volts; and
D is the theoretical capacity of the cell (Watt-hrs).

21. An alkaline battery comprising:
a cathode comprising an active cathode material including a nickel oxyhydroxide;
an anode comprising zinc or zinc alloy particles, wherein between 35 and 75 wt % of the particles are of −200 mesh size or smaller;
a separator between the anode and the cathode; and
an alkaline electrolyte contacting the anode and the cathode; wherein said cathode comprises conductive carbon particles comprising a graphite with a crystalline structure having a Raman defect ratio less than about 0.250, thereby enabling said graphite with oxidation resistant properties.

22. The battery of claim 21 wherein the oxidation resistant graphite has a Raman defect ratio of between about 0.050 and 0.250.

23. The alkaline cell of claim 21 wherein said oxidation resistant graphite has a Raman defect ratio of between about 0.050 and 0.15.

24. The battery of claim 21 wherein said nickel oxyhydroxide and said oxidation resistant graphite are in particulate form, wherein said nickel oxyhydroxide has an average particle size between about 2 and 50 micron and said oxidation resistant graphite has an average particle size between about 1 and 50 micron.

25. The battery of claim 21 wherein said nickel oxyhydroxide and said oxidation resistant graphite are in particulate form, wherein said nickel oxyhydroxide has a an average particle size between about 5 and 30 micron and said oxidation resistant graphite has an average particle size between about 5 and 30 micron.

26. The battery of claim 21 wherein said nickel oxyhydroxide and said oxidation resistant graphite are in particulate form, wherein said nickel oxyhydroxide has a an average particle size between about 5 and 20 micron and said oxidation resistant graphite has an average particle size between about 2 and 10 micron.

27. The battery of claim 21 wherein said oxidation resistant graphite is a synthetic graphite.

28. The battery of claim 21 wherein said oxidation resistant graphite comprises between about 10 and 100 wt % of said conductive carbon particles.

29. The battery of claim 21, wherein the anode comprises zinc alloy particles including at least one metal selected from indium, bismuth, tin, or aluminum.

30. The battery of claim 21, wherein the nickel oxyhydroxide is a beta-nickel oxyhydroxide, a cobalt oxyhydroxide-coated beta nickel oxyhydroxide, a gamma-nickel oxyhydroxide, or a cobalt oxyhydroxide-coated gamma-nickel oxyhydroxide.

31. The battery of claim 21, wherein the nickel oxyhydroxide includes particles having outer surfaces that approximate spheres, spheroids or ellipsoids.

32. The battery of claim 31 wherein the nickel oxyhydroxide particles have an average particle size ranging from 5 to 30 microns.

33. The battery of claim 21 wherein said battery is a primary nonrechargeable battery.

34. The battery of claim 21, wherein the cathode includes a mixture of nickel oxyhydroxide and gamma-manganese dioxide.

35. The battery of claim 21, wherein the cathode includes between 3 wt % and 12 wt % conductive carbon particles.

36. The battery of claim 21, wherein the cathode includes between 6 wt % and 10 wt % conductive carbon particles.

37. The battery of claim 21, wherein the carbon particles include expanded graphite, natural graphite, or a blend thereof.

38. The battery of claim 21, wherein the carbon particles include natural graphite particles having a particle size ranging between 2 and 50 microns.

39. The battery of claim 21, wherein the carbon particles include expanded graphite particles having a particle size ranging between 0.5 and 30 microns.

40. The alkaline cell of claim 21 wherein said oxidation resistant graphite has a total ash content of less than 0.1 percent by weight.

41. The alkaline cell of claim 21 wherein said oxidation resistant graphite has a B.E.T specific surface area of less than 15 m²/g.

42. The alkaline cell of claim 40, wherein the oxidation resistant graphite has a high degree of crystallinity, characterized by having a value for crystallite size, in the “c” crystal axis direction, L_{c}, of greater than 150 nanometers and a d₀₀₂ lattice constant of less than 0.3356 nanometers.

43. The battery of claim 21, wherein at least 45 wt % of the zinc or zinc alloy particles are of −325 mesh size or smaller.

44. The battery of claim 21, wherein the zinc or zinc alloy particles are generally acicular, having a length along a major axis at least two times a length along a minor axis.

45. The battery of claim 21, wherein the particles are generally flakes, each flake generally having a thickness of no more than 20 percent of the maximum linear dimension of the particle.

46. The battery of claim 21 including a housing, wherein a side of said housing faces said cathode, wherein said side of the housing facing the cathode has a coating thereon comprising said oxidation resistant graphite with a crystalline structure having a Raman defect ratio of less than 0.250.

47. The battery of claim 21 including a housing, wherein a side of said housing faces said cathode, wherein said side of the housing facing the cathode has a coating thereon comprising said oxidation resistant graphite with a crystalline structure having a Raman defect ratio of between 0.050 and 0.250.
